(19) United States
(12) Patent Application Publication
(10) Pub. No.: US 2002/0157327 A1
(43) Pub. Date: Oct. 31, 2002

(54) Method of handling a structure and equipment of handling the same

(76) Inventors: Masataka Aoki, Hitachi (JP); Kouichi Ushiroda, Hitachi (JP); Takahiro Adachi, Hitachi (JP); Kazuaki Kobayashi, Funabashi (JP); Masatoshi Yoshizaki, Sayama (JP); Tatsuo Fukuda, Hitachi (JP); Tomoya Toshida, Hitachi (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/125,608

(22) Filed: Apr. 19, 2002

(30) Foreign Application Priority Data
Apr. 11, 2002 (JP) 2002-108683
Apr. 27, 2001 (JP) 2001-130580
Nov. 11, 2001 (JP) 2001-348171

(51) Int. Cl. E04H 12/34; E04G 21/14; B66C 1/00

(52) U.S. Cl. 52/125.2; 52/124.2; 212/270

(57) ABSTRACT

The present invention provides a method of handling a structure and an equipment of handling the structure which can make swing of the structure to be transported small when the structure in a reactor building is curried out from the reactor building and/or when the structure is carried into the reactor building from the outside of the reactor building.

The method of handling a structure in accordance with the present invention comprises the steps of setting a beam outside a building inside of which a reactor pressure vessel is installed, the beam passing above the reactor pressure vessel and crossing over the building; setting a lifting machine having a lifting device for lifting an object to be lifted onto the beam, the lifting machine being moved on the beam; carrying in a shield for shielding radioactive rays radiated from the reactor pressure vessel into the building through an opening portion provided in a roof of the building; carrying out the reactor pressure vessel inside the building together with the shield upward through the opening portion using the lifting device; moving the lifting machine holding the reactor pressure vessel on the beam until a position where the building does not exist below the reactor pressure vessel; and lifting down the reactor pressure vessel using the lifting device to mount the reactor pressure vessel onto a transporting machine.

### BACKGROUND OF THE INVENTION

1. Field of the Invention

The present invention relates to a method of handling a large structure (a reactor pressure vessel, core internal S or the like) inside a reactor building in a nuclear power plant when the large structure is replaced and an equipment of handling the large structure.

2. Prior Art

A nuclear power plant is designed so as to have a sufficient margin to a service time required at its construction time, and the lifetime of the nuclear power plant can be extended (lengthened) by replacing components or large structures reaching its lifetime. A first conventional technology of carrying a reactor pressure vessel (hereinafter, referred to as an RPV), which is one of such component and large structure out of a reactor building and then a new reactor pressure vessel in to the reactor building is disclosed in Japanese Patent Application Laid-Open No.8-262190. It is described in Japanese Patent Application Laid-Open No.8-262190 that the method of carrying out and in the RPV at replacing the RPV uses a frame placed so as to cross over the reactor building and a containing installation mounted on the frame; a crane for lifting up the RPV from the reactor building to the containing installation and a traveling device moving on a floor of the containing installation; and a tower crane for lifting down the RPV mounted on the frame and transferred in the containing installation outside the containing installation and a moving traveling device for transferring the RPV lifted down by the tower crane to a maintenance building.

Further, a second conventional technology is disclosed in Japanese Patent Application laid-Open No.8-62368. In a method described in Japanese Patent Application laid-Open No.8-62368, a clean room covering an opening in a roof of a reactor building is formed adjacently to the reactor building, and core internals, control rod drive housings (hereinafter, referred to as CRD housings) and an RPV are carried out as a unit and are moved into the clean room. Further, in a method described in Japanese Patent Application laid-Open No.8-62368, the core internals, the CRD housings, the RPV and a γ-shield are carried out as a unit and are moved into the clean room.

Further, a third conventional technology of carrying an RPV out of and into a reactor building is disclosed in Japanese Patent Application laid-Open No.9-145882. In a method described in Japanese Patent Application laid-Open No.9-145882, at carrying out an RPV, while a large block of the RPV including the core internals and the CRD housings is being lifted up in a unit without removing the reactor shielding wall arranged around an RPV, a cylindrical temporary radiation shield is attached on the outer surface of the large block to seal the large block with the temporary radiation shield, and the large block is carried out of the reactor building using a large moving crane.

### SUMMARY OF THE INVENTION

The RPV for output power of 1100 MWe class handled in the above-described conventional technologies has a height of about 25 to 30 m, a diameter of about 6 m and a weight of about 1100 tons, and the large structure including the temporary radiation shield of about 500 tons and the lifting tool has a weight of about 1700 tons. The size of the reactor building is a rectangle having a height of 50 to 60 m and a width and a depth of 40 to 50 m. In the carrying-out/carrying-in work such as the RPV replacing work, it is necessary to secure high safety.

In the first conventional technology described above, a large tower crane or a large crawler crane of a large capacity is necessary to lift down the RPV from the frame to the traveling device on the ground, and to lift up the new RPV from the traveling device on the ground to the frame, and further to install the crane for lifting up the RPV and to install the containing installation. However, there is no description in Japanese Patent Application Laid-Open No.8-262190 on the structure of the crane for lifting up the RPV from the reactor building into the containing installation. The crane for carrying out the RPV having the total weight of 1700 tons becomes a huge structure.

Although the large moving crane is used for carrying in and out the RPV in the second and the third conventional technologies described above, a crane having a capacity of about 2000 ton class is necessary, and accordingly the crane installed on the ground has a width of about 30 m and a length above 50 m. Since the auxiliary facilities and the under ground pipes are arranged around the reactor building, such a huge moving crane needs to secure a wider area in order to be operated, and may be interfered with the auxiliary facilities and the under ground pipes. Further, in order to assemble such a huge moving crane, a wide area having a width of about 50 m and a length of 200 to 300 m is required. Particularly, the weight of the RPV used for the nuclear power plant is different depending on the output power of the reactor. Therefore, in order to carry out the different weight RPVS, it is necessary to prepare various kinds of huge cranes.

The inventors of the present invention have studied on requirements in regard to the replacing work of RPV. As the result, it is cleared to make preventive measures for the following requirements. That is, the requirements are that occurrence of incidents such as toppling of the lifting machine and breaking of a wire must be prevented; and that even if the RPV is dropped down due to the incident such as toppling of the lifting machine or breaking of the wire, radioactive substances must be prevented from releasing to the outside out of the reactor building.

Further, the inventors of the present invention have found two important problems in order to satisfy the above-described requirements. That is, one of the problems is that the lifting machine for transporting the RPV is constructed so that the object to be lifted can be reliably transported on a planned path. It has been judged that this construction includes a construction having a small probability of the toppling and the break of the wire. Whenever a heavy object is lifted up using a crane, the lifted object is always swung due to the lifting-up motion. Further, when wind is blowing during lifting up the object, the lifted object is also swung due to the wind. The inventors of the present invention have found that when the heavy object such as the RPV is lifted up, motion of the center of weight of the lifted object caused by swing must be avoided as small as possible because the difference between the weight of the crane itself and the weight of the lifted object becomes small. That is, it is necessary to prevent the RPV from moving off from the outside of a planed range. The other of the problems is that even if the RPV is moved off from the outside of the planed range due to some cause, it is necessary to establish a method of carrying in and out the RPV which can prevent the RPV from damaging the spent fuel pool and from contacting with a fuel assembly in the spent fuel pool. By doing so, even if the RPV is moved off from the outside of the planed range, the fuel assemblies will be not influenced by the motion of the RPV.

In any of the conventional technologies described above, such points are not taken into consideration.

An object of the present invention is to provide a method of handling a structure and an equipment of handling the structure which can make swing of the structure to be transported small when the structure in a reactor building is curried out from the reactor building and/or when the structure is carried into the reactor building from the outside of the reactor building.

In order to attain the above object, a method of handling a structure in accordance with the present invention comprises the steps of setting a beam outside a building inside of which a reactor pressure vessel is installed, the beam passing above the reactor pressure vessel and crossing over the building; setting a lifting machine having a lifting device for lifting an object to be lifted onto the beam, the lifting machine being moved on the beam; carrying in a shield for shielding radioactive rays radiated from the reactor pressure vessel into the building through an opening portion provided in a roof of the building; carrying out the reactor pressure vessel inside the building together with the shield upward through the opening portion using the lifting device; moving the lifting machine holding the reactor pressure vessel on the beam until a position where the building does not exist below the reactor pressure vessel; and performing any one of lifting down the reactor pressure vessel using the lifting device to mount the reactor pressure vessel onto a transporting machine and lifting down the reactor pressure vessel into a storage building using the lifting device.

According to the above method, swing of the structure lifted by the lifting machine can be made small by moving the lifting machine on the beam.

### BRIEF DESCRIPTION OF DRAWINGS

FIG. 1 is a flowchart showing an embodiment of a method of replacing an RPV.

FIG. 2 is a schematic vertical cross-sectional view showing a reactor building of a BWR plant to which RPV replacing work is applied.

FIG. 3 is a plan view showing an operating floor of the reactor building of FIG. 2.

FIG. 4 is a perspective view showing a reactor building in the state that a beam frame is installed to the reactor building.

FIG. 5 is a perspective view showing a reactor building in the state that a beam frame is attached to the reactor building in a case where a turbine building is build in the back of and adjacent to the reactor building.

FIG. 6 is an overall view showing a beam frame feeding system and a jack system.

FIG. 7 is a detailed view showing the construction of the jack system of FIG. 6.

FIG. 8(A) is a view showing the procedure of a method of assembling a beam frame using the beam frame feeding system.

FIG. 8(B) is a view showing the procedure of the method of assembling the beam frame using the beam frame feeding system.

FIG. 9 is a schematic vertical cross-sectional view showing the state that the beam frame is setting using a roller by setting trusses on the roof of the reactor building.

FIG. 10 is a schematic vertical cross-sectional view showing the state that the beam frame is setting using a crane.

FIG. 11(a) is a view showing the structure of a jack type lifting device using rods, and FIG. 11(b) is a detailed view showing the portion B of FIG. 11(a), and p FIG. 11(c) is a detailed view showing the portion C of FIG. 11 (b).

FIG. 11(A) is an explanatory view showing the operation of lifting-up using the jack type lifting device.

FIG. 12 is a vertical cross-sectional view of the reactor building showing a method of setting the jack type lifting device on the beam frame above the rooftop of the reactor building.

FIG. 13 is a partially broken perspective view showing the structure of the roof of the reactor building.

FIG. 14 is a view seeing from the arrow E-E of FIG. 13, and is a perspective view showing the state that the main beam is supported by the beam frame.

FIG. 15 is a schematic vertical cross-sectional view of the reactor building in the state that a temporary opening is set.

FIG. 16(a) is a schematic cross-sectional view of the reactor building in the situation that a protective wall is set inside the reactor well, and FIG. 16(b) is a detailed view of a part of the protective wall of FIG. 16(a).

FIG. 17 is a plan view showing the operating floor of the reactor building in the situation that the protective wall is set inside the reactor well.

FIG. 18 is a schematic cross-sectional view showing the reactor building in the situation that a fuel protective wall is set in an upper portion of a reactor shielding wall.

FIG. 19 is a schematic cross-sectional view showing the reactor building in the situation that the protective wall is set on the operating floor around the reactor well.

FIG. 20 is a schematic cross-sectional view showing the reactor building in the situation that an expandable telescopic structure (a hydraulic jack or the like) also serving as a protective wall is set on the operating floor around the reactor well.

FIG. 21 is a schematic vertical cross-sectional view showing the rooftop portion of the reactor building in the state that an RPV shield is set in the upper portion of the reactor shielding wall.

FIG. 21(A) is a schematic vertical cross-sectional view showing the rooftop portion of the reactor building in the state that an RPV shield is set in the upper portion of the reactor shielding wall.

FIG. 22 is a cross-sectional view showing the reactor building in the state that the RPV is lifted up by rods of a jack type lifting device, and the upper portion of the RPV is in contact with the bottom surface of the upper portion of the RPV temporary radiation shield.

FIG. 23 is a view seeing from the arrow G-G of FIG. 22.

FIG. 24 is a schematic vertical cross-sectional view showing the reactor building in the state that the RPV is lifted up by a jack type lifting device and is being carried out from the reactor building.

FIG. 24(A) is a schematic vertical cross-sectional view showing the reactor building in the state that the RPV is lifted up by a jack type lifting device and is being carried out from the reactor building.

FIG. 25 is a schematic vertical cross-sectional view showing the reactor building in the state that the RPV is being lifted down onto the ground using the jack type lifting device.

FIG. 25(A) is a schematic vertical cross-sectional view showing the reactor building in the state that the RPV is being lifted down into a storage building on the ground using the jack type lifting device.

FIG. 26 is a schematic vertical cross-sectional view showing the state that the RPV and the RPV shield are lifted up together in contacting the top head of the RPV with the upper portion of the RPV shield.

FIG. 27 is a schematic vertical cross-sectional view showing the state that the RPV and the RPV shield are lifted up together in contacting the stabilizer lug of the RPV with the upper portion of the RPV shield.

FIG. 28 is a view seeing from the arrow H-h of FIG. 27.

FIG. 29 is a schematic vertical cross-sectional view showing the reactor building in the state that a new RPV is being carried into the reactor building.

FIG. 30 is an enlarged view showing a traveling device.

FIG. 31 is a view showing the state the RPV is being carried out from the reactor building using a jack type lifting device.

FIG. 32 is a view showing the state the RPV is being carried out from the reactor building using a jack type lifting device.

FIG. 33 is a view showing the structure inside the hydraulic jack.

FIG. 34 is a schematic vertical cross-sectional view showing the reactor building in the state that the protective wall supported by plate-shaped protective wall supporting members is installed in the reactor well.

FIG. 35 is a plan view showing the operating floor of the reactor building in the state that the protective wall of a column structure is installed in the reactor well.

FIG. 36(a) is a plan view showing the operating floor of the reactor building in the state that the protective wall of a column structure having a reinforcing member is installed in the reactor well, and FIG. 36(b) is a schematic vertical cross-sectional view of FIG. 36(a).

FIG. 37(a) is a schematic vertical cross-sectional view showing the reactor building in the state that the protective wall having rod-shaped guides is installed in the reactor well, and FIG. 37(b) is a plan view of the operating floor of FIG. 37(a).

FIG. 38 is a schematic plan view showing the reactor building in the state that the protective wall having an additional guide is installed in the reactor well.

FIG. 39(a) is a schematic vertical cross-sectional view showing the reactor building in the state that the protective wall having decelerating guides is installed in the reactor well, and FIG. 39(b) is a plan view of the operating floor of FIG. 39(a).

FIG. 40 is a schematic vertical cross-sectional view showing the reactor building in the state that the protective wall having decelerating guides inclining downward is installed in the reactor well.

FIG. 41 is a schematic vertical cross-sectional view showing the reactor building in the state that the RPV is decelerated by the decelerating guides.

FIG. 42 is a schematic vertical cross-sectional view showing the reactor building in the state that the protective wall having decelerating guides in the upper side and guides in the lower side is installed in the reactor well.

FIG. 43 is a schematic vertical cross-sectional view showing the reactor building in the state that the protective wall having decelerating guides in the upper side and rod-shaped guides in the lower side is installed in the reactor well.

FIG. 44(a) is a plan view showing the operating floor of the reactor building in the state that the protective wall having supporting plates is installed in the reactor well, and FIG. 44(b) is a schematic vertical cross-sectional view of FIG. 44(a).

FIG. 45 is a plan view showing the operating floor of the reactor building in the state that the protective wall having supporting plates not covering over opening portions of the spent fuel pool and the component pool is installed in the reactor well.

FIG. 46 is a plan view showing the operating floor of the reactor building in the state that the protective wall having supporting plates completely covering over opening portions of the spent fuel pool and the component pool is installed in the reactor well.

FIG. 47 is a plan view showing the operating floor of the reactor building in the state that the protective wall supported by the supporting members is installed in the reactor well, the lower end of each of the supporting members being positioned at a position on the operating floor just above the reinforcing member of the reactor building.

FIG. 48 is a plan view showing the operating floor of the reactor building in the state that the protective wall supported by the supporting members is installed in the reactor well, the lower end of each of the supporting members being positioned at a position on the operating floor just above the reinforcing member of the reactor building.

FIG. 49 is a plan view showing the operating floor of the reactor building in the state that the protective wall supported by the supporting members is installed in the reactor well, the lower end of each of the supporting members being positioned at a position on the operating floor just above the reinforcing member of the reactor building.

### DESCRIPTION OF THE PREFERRED EMBODIMENTS

(Embodiment 1)

As a preferred embodiment of a method of handling a structure in accordance with the present invention, an embodiment of applying the present invention to replacement of an RPV will be described below. In this embodiment, a jack type lifting machine is used for carrying in and out the RPV.

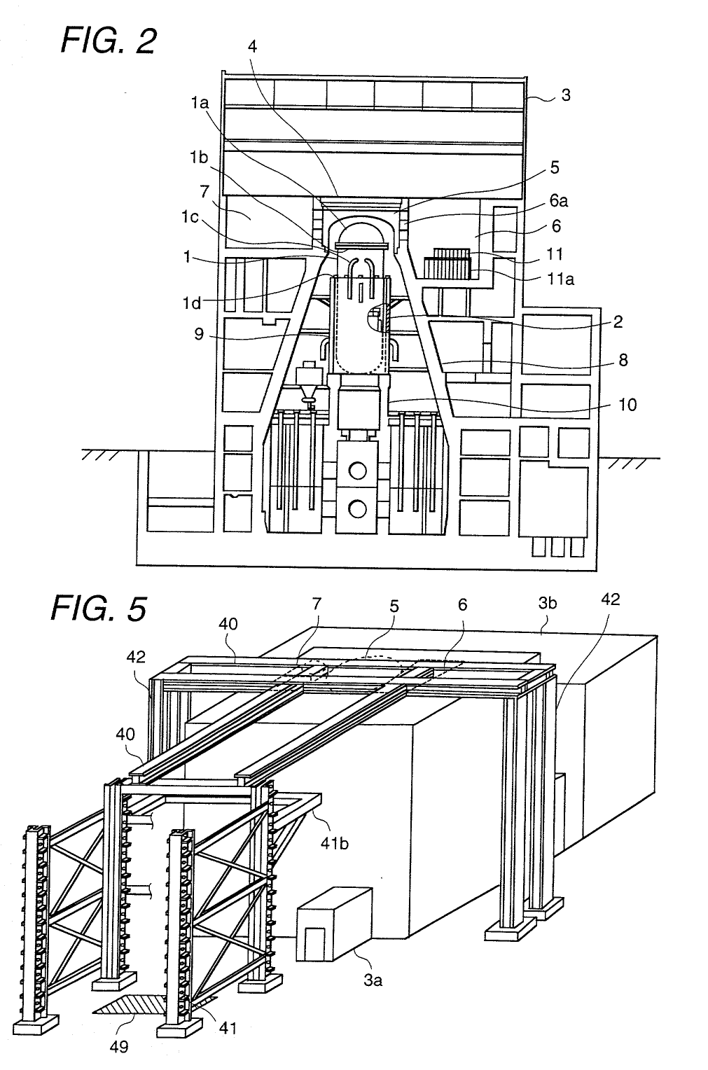

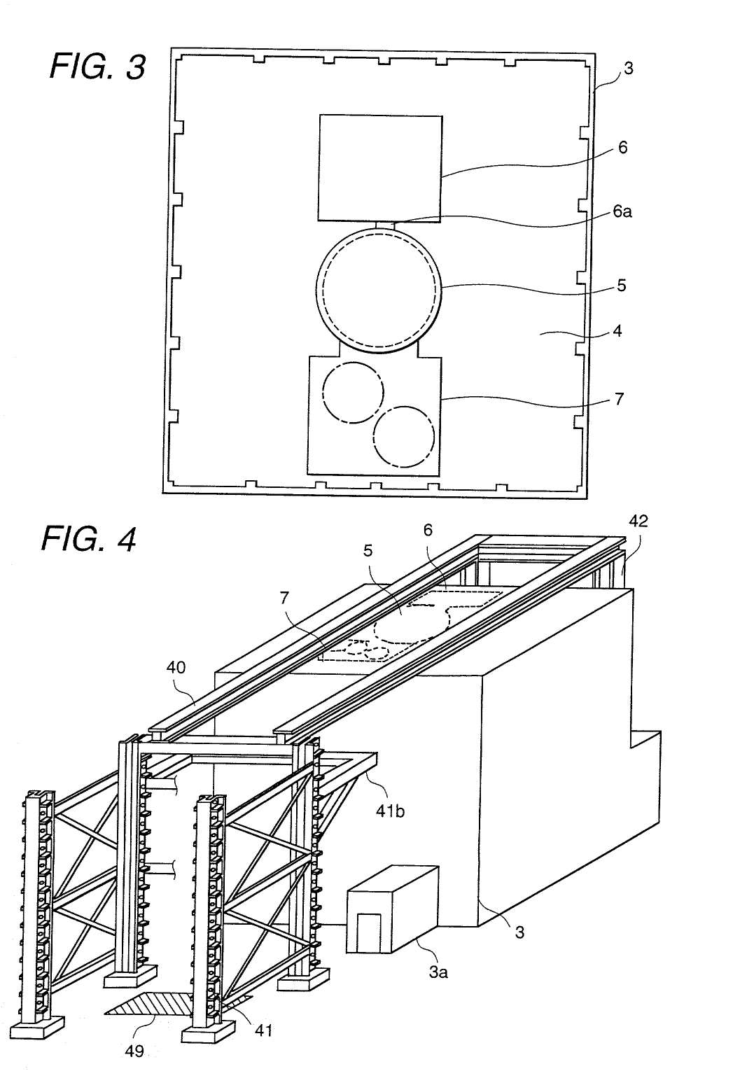

Description will be made on the outline of the structure of a reactor building structure for a boiling water reactor power plant (a BWR plant) to which RPV replacement work is to be performed, referring to FIG. 2 and FIG. 3. A reactor container (hereinafter, referred to as a PCV) 8 for containing an RPV 1 is installed in a reactor building 3. In the portion above the PCV 8, there is provided a reactor well 5 to be filled with shielding water for shielding radioactive rays from fuel assemblies 11 when the fuel assemblies 11 are replaced and when a core internal 2 of a structure inside the RPV 1 is carried out. When the RPV 1 is replaced, the RPV 1 is carried out/in through the reactor well 5. A component pool 7 for storing the carried-out core internals 2 is arranged adjacently to the reactor well 5. The spent fuel pool 6 for storing the spent fuel assemblies 11 is arranged on an operating floor 4 adjacently to the reactor well 5. In the spent fuel pool 6, a fuel rack 11a for storing the spent fuel assemblies 11 is arranged.

The RPV 1 is placed on a pedestal 10, and self-stands by being fixed to the pedestal with anchor bolts, not shown. The pedestal 10 is a structure serving as a base of the RPV 1, and therefore, is made of concrete and reinforcing bars. A reactor shielding wall (hereinafter, referred to as an RSW) 9 for shielding radioactive rays from the RPV 1 and the core internals 2 is arranged outside the RPV 1. The RSW 9 is a concrete structure with iron plate frame having a thickness of 600 to 700 mm. A top head 1a of the head of the RPV 1 is fixed to a flange 1b of the RPV 1 with bolts. Nozzles such as a main steam nozzle 1c and so on are attached to the RPV 1 to be connected to pipes outside the RPV 1. An RPV stabilizer lug 1d of an aseismatic support for the RPV 1 is attached to the lower portion of the main steam nozzle 1c, and is fixed to an RPV stabilizer bracket, not shown, arranged in the upper portion of the RSW 9 with bolts.

On the operating floor 4 inside the reactor building 3, the spent fuel pool 6 and the component pool 7 are arranged interposing the reactor well 5. That is, the spent fuel pool 6 is arranged in the opposite side of the component pool 7 with respect to the position of the reactor well 5. The spent fuel pool 6 is filled with water in order to shield the radioactive rays from the spent fuel assemblies 11 and to cool the spent fuel assemblies 11. A gate 6a is provided between the reactor well 5 and the spent fuel pool 6. When the fuel assemblies of the reactor core are transferred to the spent fuel pool 6, the inside of the reactor well 5 is filled with water and then the gate 6a is opened to transfer the fuel assemblies under the water.

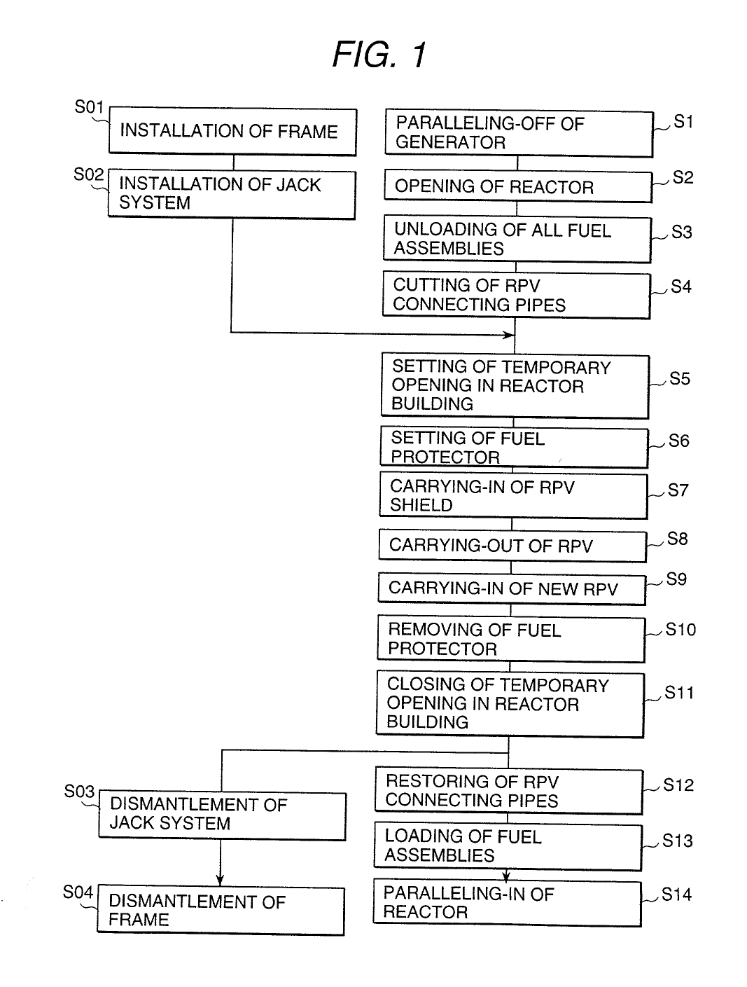

The procedure of work in the method of handling a structure according to the present invention is shown in FIG. 1. Before shutting down the reactor to be performed with RPV replacing work, a frame is initially installed so as to cross over the reactor building 3, in Step 01. FIG. 4 shows the state that the frame is installed so as to cross over the reactor building. When the RPV is moved to an RPV lifting-down position 49, beam frames 40 are stretched over the reactor building 3. The beam structure 40 is supported by a jack hoisting column 41, a beam frame column 42 and receiving beam 41b. The upper surface of the beam frame 40 is flat so that a traveling device having wheels may travels on the upper surface. The beam frame 40 is used as a rail (that is, a traveling rail), but, here, it is called as the beam frame for the sake of convenience. Further, it is hereinafter called as the beam frame. A large article carrying-in port 3a is used for carrying a large machine into or out of the reactor building 3. Further, in the figure, the position of each of the operating floor 4, the spent fuel pool 6 and the component pool 7 seeing from the upside of the reactor building is illustrated by a dotted line. The beam frame 40 is arranged so that the RPV to be carried out/carried in may not pass above the spent fuel pool 6.

The beam frame 40 and the jack hoisting column 41 are arranged so as to carry out/carry in the RPV in a direction that the distance between the RPV and the fuel pool seeing from the upside at carrying in/carrying out becomes longer than the distance between the RPV and the fuel pool during operation. It is preferable that the jack hoisting column 41 is installed in the side of the large article carrying-in port 3a of the reactor building. By doing so, the jack hoisting column 41 can be set using an area for moving the carried-in large article provided near the large article carrying-in port 3a.

In a case of a plant where a turbine building 3b is arranged adjacently to the reactor building 3, or in a case where the beam frame column 42 can not install in the opposite side of the RPV lifting-down position 49 of the reactor building 3 because of the situation of component arrangement in the plant site, the beam frames are arranged as shown in FIG. 5. That is, the beam frames 40 are arranged in a T-letter shape, and the beam frames 40 are supported by the jack hoisting columns 41, the beam frame columns 42 and the receiving beam 41b.

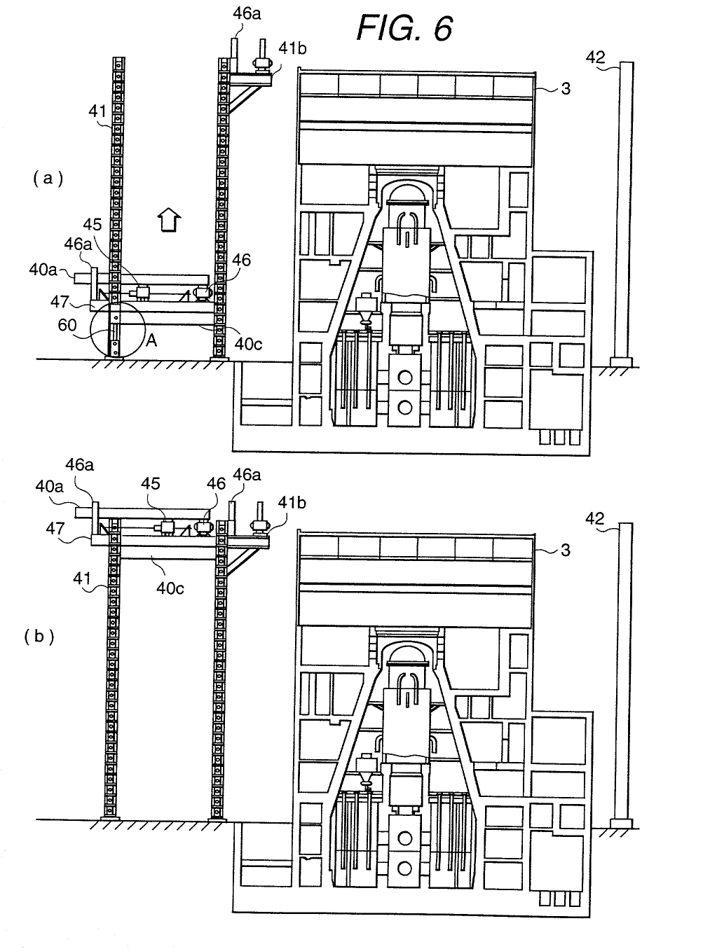

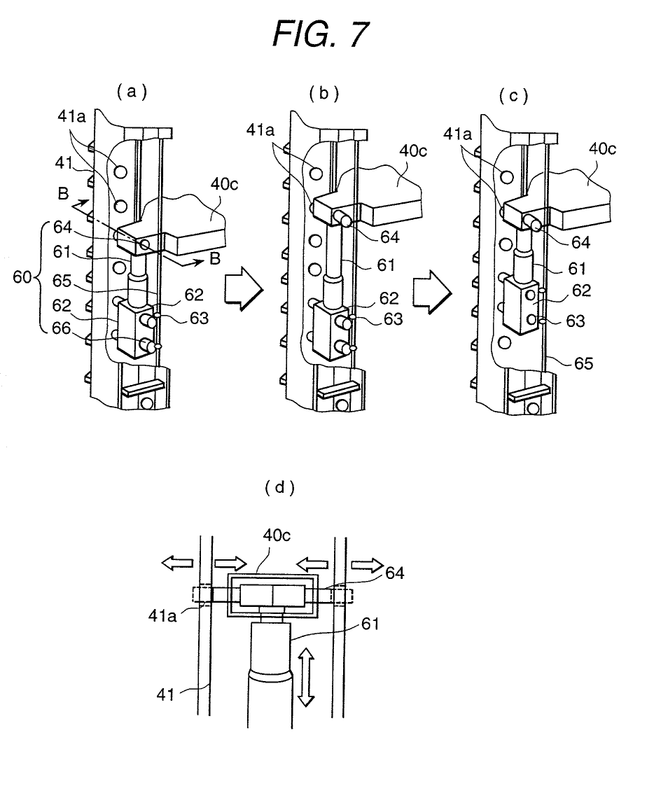

The installation of the beam frames 40 above the roof of the reactor building 3 is performed through a method of feeding the beam frames. FIG. 6 is a schematic vertical cross-sectional view of the reactor building showing the method of assembling the beam frame. FIG. 7 shows the portion A in FIG. 6, and FIG. 7(a) to FIG. 7(c) are views showing the hoisting procedure of the jack type hoisting device for setting the jack type lifting machine for lifting the RPV lifting on the beam frame above the roof of the reactor building. FIG. 7(d) is a detailed cross-sectional view of a holding jack of the jack type hoisting device being taken on the plane of the line B-B of FIG. 7 (a).

The procedure of hoisting the beam frame members 40a to the setting position using the jack type hoisting device will be described below.

As shown in FIG. 6(a), the jack hoisting columns 41 and the beam frame columns 42 are initially installed using a crane. Next, a frame table 47 having a beam frame feeding jack 45 and a roller 46 is attached to a frame table 40c provided in the lower portion of the jack hoisting columns 41. The beam frame member 40a is mounted on the beam frame feeding jack 45 and the roller 46, and the frame table 40c is hoisted up using the jack type hoisting device 60.

It is preferable that total number of the jack hoisting columns 41 and the beam frame columns 42 is 6 in the minimum. This figure shows a case where the number of the jack hoisting columns 41 is 4 and the number of the beam frame columns 42 is 2. Even in a case where the total number is 7 or more by employing a truss structure in order to increase the strength of the jack hoisting columns 41 and the beam frame columns 42, it is possible to perform the RPV replacement using a narrow site area if the total number is 16 or less.

The procedure of hoisting up the frame table 40c along the jack hoisting column 41 is as follows. As shown in FIG. 7(a), the jack type hoisting device 60 is initially attached to the frame table 40, and a jack table 62 is held to pin holes of the jack hoisting column 41 using pins 63, and a holding pin 64 is made in a state contained in the frame table 47. As shown in FIG. 7(d), the holding pin 64 for holding the position of the frame table 47 is extendable to the pin hole 41a provided in the jack hoisting column 41 (the pin 63 is also extendable). Further, the hoisting jack 61 is extendable in the longitudinal direction of the jack hoisting column 41.

As shown in FIG. 7(b), the hoisting jack 61 held to the jack hoisting column 41 by the pin 63 is extended to hoist the frame table 47, and the holding pin 64 is projected and inserted into the pin hole 41a to hold the frame table 47. Next, as shown in FIG. 7(c), the pin 63 is contained inside the jack table 62, and the hoisting jack 61 is contracted to pull the hoisting jack 61 up to the position of the pin hole 41a in the upper portion along a guide rail 65. A guide shoe 66 attached to the jack type hoisting device 60 guides hoisting of the jack type hoisting device 60 by moving along the guide rail 65. Next, the pin 63 is projected and inserted into the pin hole 41a, and then the holding pin 63 is contained into the jack table 62. Thus, the state is returned to the state of FIG. 7(a) described above, and the jack is moved by one pin upward. By repeating the procedure after that, the frame table 47 is moved up to transport the beam frame member 40a toward the upper portion of the jack hoisting column 41. Although the frame table 47 is moved upward by one pitch of the pin hole 41a by one jack operation, the frame table 47 may be moved upward by plural pitches of the pin hole 41a by one jack operation by setting the stroke of the hoisting jack 61 longer. In such a case, the time required for lifting up the frame table can be shortened. By repeating the above-described operation, the jack type hoisting device 60 lifts up the frame table 40c to the upper portion of the jack hoisting column 41, as shown in FIG. 6(b).

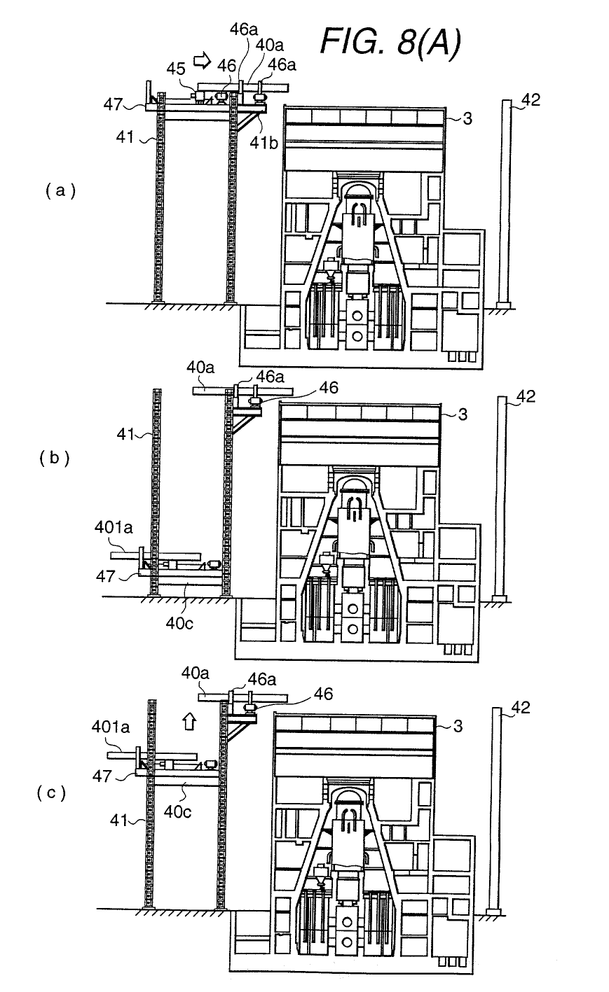

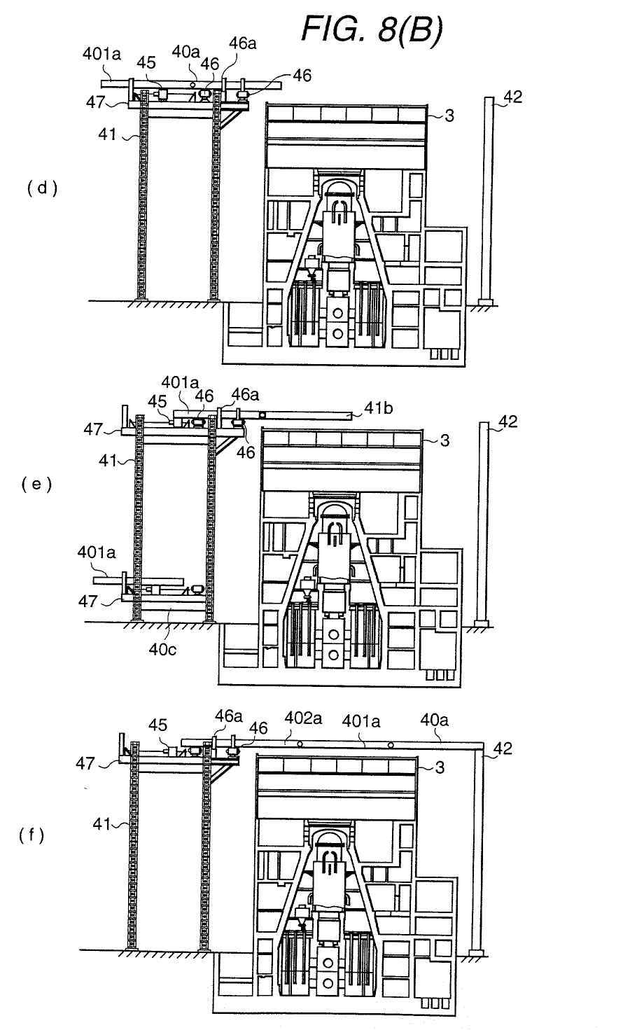

Next, the beam frame member 40a is fed toward the portion above the roof of the reactor building 3 using the beam frame feeding jack 45 and the roller 46. Description will be made below on the procedure of feeding the beam frame toward the portion above the roof of the reactor building using the beam frame feeding jack 45 and the roller 46, referring to FIG. 8(a) to (c).

As shown in FIG. 8(a), the beam frame member 40a lifted up by the jack hoisting device is fed toward the portion above the roof of the reactor building by moving the beam frame member 40a on the roller 46 using the beam frame feeding jack 45. Next, the fed beam frame member 40a is held by a beam receiver 46a placed on the receiving beam 41b.

Next, the beam table 40c and a beam table 47 attached to the beam table 40c is lowered down to the lower portion of the jack hoisting column 41 in the procedure inversed to the procedure described above to attach the beam frame member 401a (FIG. 8(b)). Then, the beam table 40c is raised up to the upper portion of the jack hoisting column 41 (FIG. 8(c)). The beam table 40c is raised up to the upper portion of the jack hoisting column 41 to fasten the beam frame member 401a attached to the frame table 40c with the beam frame member 40a (FIG. 8(d)). By fastening a beam frame member 401a with the beam frame member 40a using bolts, nuts and pads, disassembling can be performed in a short time compared to the case of fastening by welding.

Through the procedure similar to the procedure at feeding the beam frame member 40a toward the portion above the roof of the reactor building 3 using the beam frame feeding jack 45 and the roller 46, the beam frame member 40a and the beam frame member 401a fastened to each other are fed toward the portion above the roof of the reactor building 3. Through the procedure similar to the procedure for the case of the beam frame member 40a and the beam frame member 401a, a beam frame member 402a is raised up to the upper portion of the jack hoisting column 41 to fasten the beam frame member 401a with the beam frame member 402a. Then, the beam frame member 40a and the beam frame member 401a and the beam frame member 402a are fed toward the portion above the roof of the reactor building 3. By doing so, the beam frame member 40a reaches the beam frame column 40a. After that, the beam frame member 40a is fastened to the beam frame column 42. Thus, setting of the beam frame 40 above the roof of the reactor building 3 is completed. Therein, in the present embodiment, the beam frame 40 is composed of the beam frame member 40a and the beam frame member 401a and the beam frame member 402a.

By setting the beam frame 40 by dividing into the beam frame members, transportation of the beam frame can be easily performed because the weight of each of the members can be reduced. Further, in comparison to the method of using a crane, the need to measure the strength of the foundation for installing the crane can be eliminated by employing the method of feeding out the beam frame. In the present embodiment, the work in Step S01 and the work in the steps after that are performed during the same scheduled inspection period, but the work in Step S01 may be performed during a scheduled inspection period before the scheduled inspection period during which the work in Step S02 and the work in steps after that are performed. By doing so, the work time per scheduled inspection can be made shorter compared to the case where the work is performed in a single scheduled inspection period. Accordingly, the shutdown time of the reactor can be shortened. By shortening the shutdown time of the reactor, the availability of the reactor can be improved.

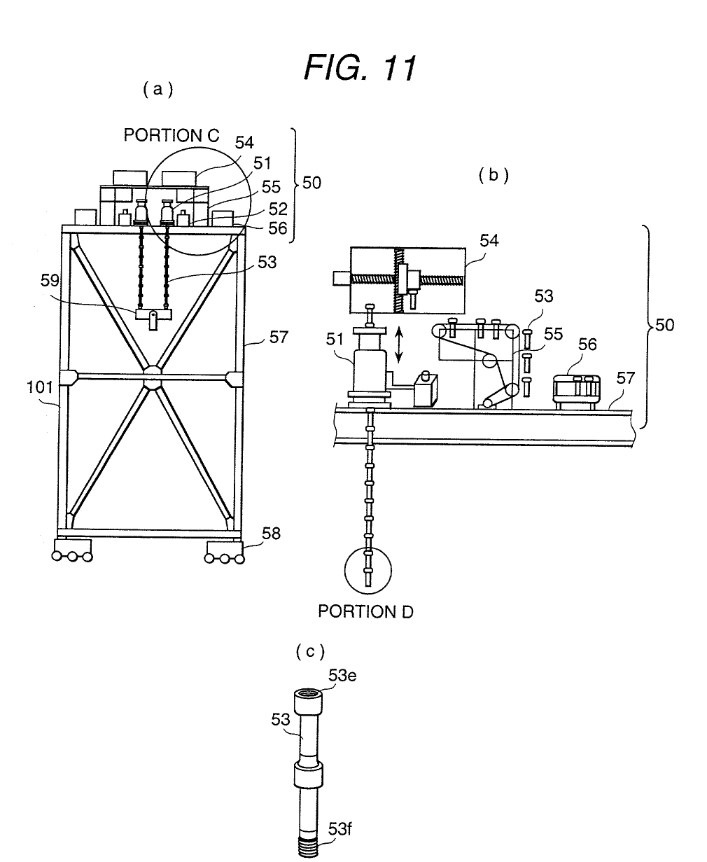

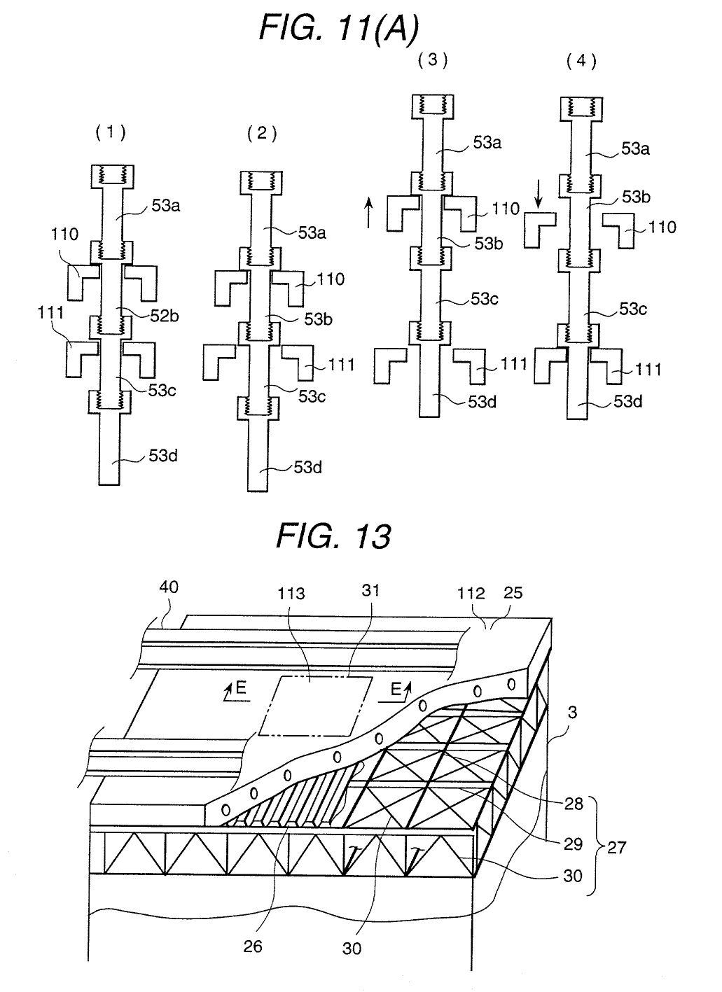

In Step S02, a jack type lifting machine 101 for carrying in and carrying out the RPV is set on the beam frame 40 crossing over the reactor building. Initially, the jack type lifting machine 101 will be described. FIG. 11 (a) is an overall view showing the jack type lifting machine 101 using rods, and FIG. 11(b) is a detailed view showing the portion C (a jack type lifting device 50) of FIG. 11(a), and FIG. 11(c) is a detailed view showing the portion D (the rods 53 of the jack type lifting device 50) of FIG. 11(b).

The jack type lifting machine 101 is a machine for lifting an object to be lifted by connecting the object to be lifted to a lifting tool 59 and by lifting the rods 53. One end of the rod 53 is formed in a female screw 53e and the other end is formed in a male screw 53f, and accordingly the rods 53 can be connected with each other in the longitudinal direction. The lifting tool 59 is connected to the lower end of the connected rods 53, and the upper end of the connected rods is held by a hydraulic jack 51. The structure of the jack type lifting machine 101 will be described below. The jack type lifting machine 101 comprises a jack type lifting device 50, a carriage 57 and traveling devices 58. The traveling devices 58 are placed under the carriage 57 to move on the beam frame 40. The jack type lifting device 50 is placed in the upper end portion of the carriage 57. The jack type lifting device 50 comprises the hydraulic jack 51, a pump unit 52 for supplying operating oil to the hydraulic jack 51, a rod attaching and detaching device 54, a rod transfer device 55 and a rod storage box 56. The rods 53 are suspended by the hydraulic jack 51.

The procedure of lifting up a structure using the jack type lifting device 50 will be described below. After attaching an object to be lifted up, not shown, to the lifting tool 59, the hydraulic jack 51 is operated in the vertical direction as shown by the arrow of FIG. 11(b) to pull the rods 53 upward. As shown by FIG. 11(A) (1), the inside structure of the hydraulic jack 51 is that each of an upper chuck 110 and a lower chuck 111 holds the rods 53. The upper chuck 110 is vertically moved by hydraulic pressure. FIG. 33 shows the inside structure of the hydraulic jack 51. The upper chuck 110 and the lower chuck 111 are moved by hydraulic pressure in the directions shown by the arrows. A hydraulic ram 110a vertically moves the upper chuck 110 by hydraulic pressure of a cylinder.

The process of the hydraulic jack 51 of lifting up the rods 53 will be described below. Here, the whole of the rods 53a to 53d connected to one another by the female screws 53e and the male screws 53f is called as a rod 53. Further, for the sake of convenience, the upper chuck 110 and the lower chuck 111 are illustrated, but the ram 110a and the cylinder are not illustrated. Initially, when the rod 53 is held, the upper chuck 110 holds the step portion of the rod 53b and the lower chuck 111 holds the step portion of the rod 53c connected to the rod 53b in the downside (FIG. 11(A) (1)). When the rod 53 is lifted up, the lower chuck 111 is initially opened (FIG. 11(A) (2)). Next, the upper chuck 110 is pushed upward by hydraulic pressure to move the rod 53 up to a position where the step portion of the rod 53d can be held by the lower chuck 111 (FIG. 11(A) (3)). Next, the rod 53d is held by the lower chuck 111, and the upper chuck 110 is opened and lowered (FIG. 11(A) (4)). The chuck 110 is lowered to holds the step portion of the rod 53c. By the process described above, the rod 53 is lifted up by the length of the rod 53c. When the rod is long, the rod is lifted upward by repeating the above operation. The uppermost rod lifted up as described above (the rod 53a in the case of FIG. 11(A)) is detached from the rod 53 using the rod attaching and detaching device 54 of FIG. 11(b). The rod attaching and detaching device 54 is a device for detaching the uppermost rod from the rod by rotating the uppermost rod. Next, the detached rod is transferred to the rod storage box 56 using a rod transfer device 55 to store it the storage box 56.

By repeating the above operation, the lifted object attached to the lifting tool 59 is lifted upward. The device for lifting up the lifted object by repeating the above operation is called as the jack type lifting device. In the present embodiment, a heavy object including the RPV is lifted using the jack type lifting machine 101 having the jack type lifting device 50. By lifting up the RPV using the jack type lifting device 50, the probability of occurrence of break in the rod 53 can be made very small. Thereby, the RPV can be lifted further safely.

The procedure of setting the jack type lifting machine 101 on the beam frame above the roof of the reactor building will be described below.

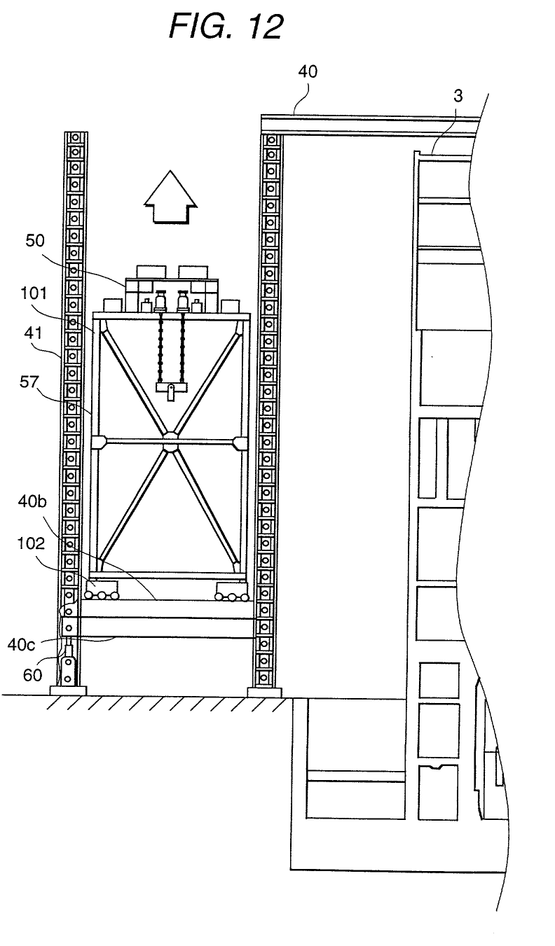

FIG. 12 is a vertical cross-sectional view showing the reactor building and the vicinity of the reactor building when the jack type lifting machine 101 is set on the beam frame above the rooftop of the reactor building. Initially, the jack type lifting machine 101 is set. That is, the beam 40b is set on the frame table 40c placed in the lower portion of the jack hoisting column 41. On the beam 40b, the traveling device 102 and the carriage 57 is attached. Then, the jack type lifting machine 101 is set on the carriage 57. A crane is used for the setting. Thus, assembling of the jack type lifting machine 101 on the beam 40b is completed. By assembling the jack type lifting machine 101 on the beam 40b, since the assembling can be performed when there is a crane capable of lifting each of the parts, it is possible to set the lifting machine on the beam 40b using a small crane which is smaller than a crane used in a case where the jack type lifting machine 101 is assembled at a place other than the place on the beam 40b and then the assembled jack type lifting machine 101 is set by being lifted and moved. Therefore, the strength of the foundation for installing the crane can be lowered compared to the case of using the large crane. However, although the jack type lifting machine 101 is assembled in the beam 40b in the present embodiment, it is possible that the jack type lifting machine 101 is assembled at a place other than the place on the beam 40b and then the assembled jack type lifting machine 101 is set by being lifted and moved. In this case, although there is the problem described above, the time for setting the jack type lifting machine 101 on the beam can be shortened compared to the case where the jack type lifting machine 101 is assembled on the beam 40b.

The beam 40b on which the jack type lifting machine 101 is mounted is lifted up to a level at which the upper surface of the beam 40b becomes equal to the upper surface of the beam frame 40. The lifting-up is performed using the jack type hoisting device 60 and the jack hoisting columns 41. Since the procedure of the lifting is similar to the procedure of Step S01, the explanation is omitted here. There, the lifting of the beam 40b may be completed at the time when the difference between the levels of the upper surface of the beam 40b and the upper surface of the beam frame 40 becomes smaller than a difference which the traveling device 102 can pass through. Next, the traveling device 102 is operated to move the jack type lifting machine 101 on the beam frame 40, and further the jack type lifting machine 101 is moved until the jack type lifting device 50 comes to a position just above the RPV 1 which is contained in the reactor building, and then the traveling device 102 is fixed.

In Step S1, a generator is paralleled off, and a scheduled inspection of the nuclear power plant is started. In Step S2, work of opening the nuclear reactor is executed. In the nuclear reactor opening work, work of removing the RPV head 1a and the core internals is executed. The removed core internals are moved to the component pool 7 adjacent to the reactor well 5. The work in Step S1 and Step S2 is the same as the work executed in the scheduled inspection. In Step S3, All the fuel assemblies in the core are extracted out of the RPV 1. In Step S3, all the fuel assemblies 11 loaded in the core are transferred to the fuel rack 11a in the spent fuel pool 6. The method of transferring the fuel assemblies is that the reactor well 5 is filled with water, and the gate 6a between the reactor well 5 and the spent fuel pool 6 is opened, and then the fuel assemblies 11 extracted from the core are transferred under the water. By removing the fuel assemblies in the core, the surface radiation dose of the RPV 1 at carrying out the RPV 1 can be reduced, and accordingly the radiation exposure of the workers can be reduced. After completion of transferring the fuel assemblies, the gate 6a is closed, and the water of the reactor well 5 is drained.

In Step S4, all the pipes connected to the RPV nozzles are cut off. The work of Step S01 and Step S02 may be performed during performing the work of Steps S1 to S4. By performing at least part of the work of Step S01 and Step S02 during performing the work of Steps S1 to S4, the work period can be shortened. By doing so, the radiation exposure of the workers can be reduced. Further, since the shut-down period of the nuclear plant can be shortened, the operation of the nuclear plant can be restarted earlier. Thereby, the operability of the nuclear plant can be improved.

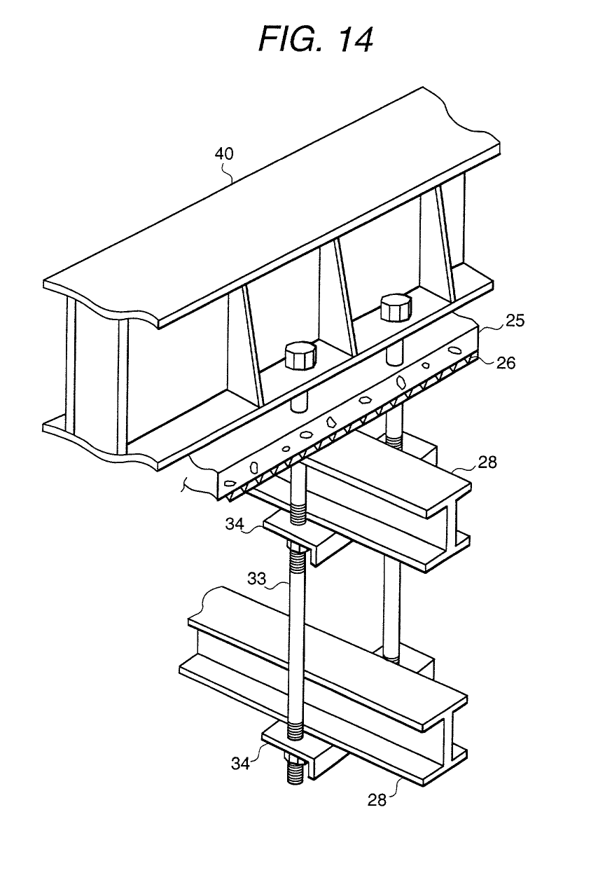

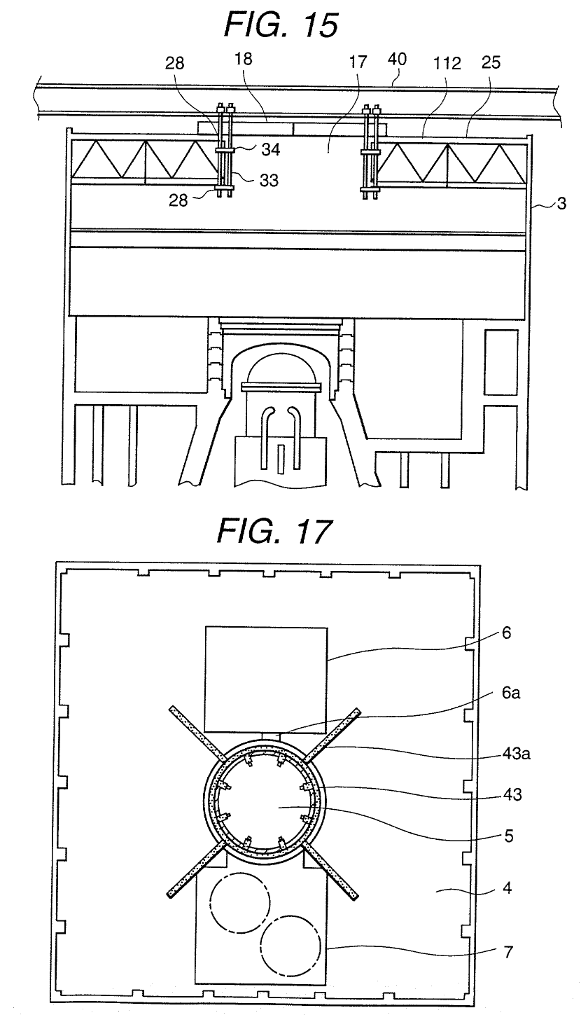

In Step S5, an opening portion capable of carrying out and carrying in the RPV is set in the roof of the reactor building. FIG. 13 is a partially broken perspective view showing the structure of the roof 112 of the reactor building 3. In this state, the lifting machine 101 has been set above a temporary opening portion set position 31, but the lifting machine 101 is not illustrated in FIG. 13. Here, a portion of the roof removed for forming the opening is called as a removed roof 113. FIG. 14 is a view seeing from the arrow E-E of FIG. 13, and is a perspective view showing the state that a main beam is supported by the beam frame. FIG. 15 is a schematic vertical cross-sectional view of the reactor building in the state that the temporary opening is set. A ceiling truss 27 is composed of the main beam 27, the main beam 28, a deck plate supporting beam 29 and a brace 30. The roof 112 has a structure that a deck plate 26 is placed on the ceiling truss 27, and concrete 25 is poured and cured on the deck plate 26. The temporary opening portion is set at the temporary opening portion set position 31 of the roof 112 having the structure described above. In order to set the temporary opening portion, it is necessary to cut off and remove a portion of the main beam 28 to be occupied by the temporary opening portion set position 31. The main beam 28 bears the weight of the roof such as the concrete and so on. Therefore, before cut off the portion of the main beam 28 to be occupied by the temporary opening portion set position 31, bolt slings 33 and brackets 34 are set from the beam frame 40 to support the main beam 28.

Anchor bolts are set to the removed roof 113 of the portion of the roof to be removed, and the anchor bolts are connected to a lifting tool 59, not shown in the figure. By doing so, it is possible to prevent the removed roof 113 from dropping down inside the reactor building 3 even when the edge portion of the temporary opening portion set position 31 is cut off. The concrete 25, the deck plate 26, the main beam 28, the deck plate receiving beam 29 and the brace 30 in the temporary opening portion set position 31 are cut using a concrete cutter or the like. The lifting tool 59 connected to the removed roof 113 is moved upward to a level at which the lowermost surface of the removed roof 113 becomes higher than the roof. Then, the fixing of the traveling device 102 is taken off, and the jack type lifting machine 101 is moved above the beam 40b via the beam frame 40. A trailer, not shown, for transporting the removed roof is placed below the jack type lifting machine 101 on the ground, and the removed roof 113 is lowered down using the jack type lifting device 50 to be mounted on the trailer. The connection between the removed roof 113 and the lifting tool 59 is taken off, and then the removed roof 113 is transported to a storing place by the trailer.

A shutter 18 to cover the temporary opening portion 17 is set at a lower portion of the lifting tool 59. The shutter 18 is formed in a unit, and can be transported by connecting to the lifting tool 59. The shutter 18 is connected to the lifting tool 59, and the shutter 18 is transferred above the temporary opening portion 17 using the jack type lifting machine 101 according to the procedure inverse to the procedure of mounting the removed roof onto the trailer. After that, the shutter 18 is lowered down on the roof 112, and the periphery of the shutter 18 is fixed to the roof 112. The state of setting the shutter 18 on the temporary opening portion 17 is shown in FIG. 15. The shutter 18 can be opened and closed. By doing so, the radiation dose outside the reactor building 3 through the temporary opening portion 17 can be reduced compared to the case without the shutter.

There, the work of Step S01, Step S02 and Step S5 may be executed during a scheduled inspection period before a scheduled inspection period in which the work of Step S6 and the following steps is executed. According to this method, the replacing work of the core internals can be performed by dividing into two scheduled inspection periods. By doing so, the work time per scheduled inspection can be made shorter compared to the case where the work is performed in a single scheduled inspection period. Accordingly, the availability of the reactor can be improved.

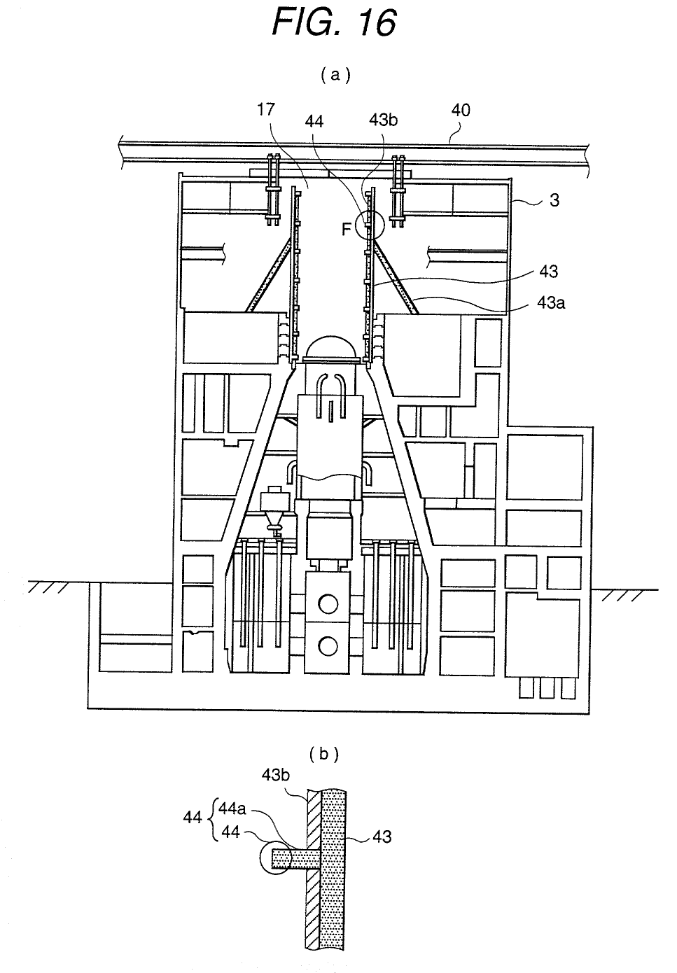

In Step S6, a protective wall is set in the reactor building 3. FIG. 16(a) is a schematic cross-sectional view of the reactor building in the situation that the protective wall is set inside the reactor well. FIG. 16(b) is a detailed view of the portion F of FIG. 16(a), and shows a guide 44 attached to the protective wall. FIG. 17 is a plan view showing the operating floor 4 of the reactor building in the situation that the protective wall is set inside the reactor well. The reference character 43 indicates the protective wall, the reference character 43a indicates a protective wall supporting member, and the reference character 44 indicates a guide for guiding carrying-out and carrying-in of the RPV 1 attached to the reactor well 5 side of the protective wall 43. The guide 44 is composed of pulleys 44b and guide brackets supporting the pulleys. The reference character 43b indicates a buffer member attached to the reactor well 5 side of the protective wall 43. The guide bracket 44a has a structure, not shown, variable of the length (a height projecting inward from the supporting member). Thereby, the positions supported by the guide can be changed depending on the case where the RPV and the shielding member are carried out together and the case where a new RPV unnecessary to attach any shielding member, that is, any RPV radiation shielding member is carried in, and accordingly the guide can guide objects having different shape. Further, even if the RPV 1 drops down, dropping of the RPV can be limited only on the pedestal by providing the protective wall. That is, the provision of the protective wall can prevent the incident that the RPV falls down on the operating floor and falls toward the spent fuel pool side to break the spent fuel pool and to damage the fuel assemblies stored in the spent fuel pool, or the incident that the RPV falls down on the operating floor and falls toward the component pool side to break the component pool and to damage the components stored in the component pool, or the incident that the RPV falls down on the operating floor and rolls on the operating floor to damage the components placed on the operating floor.

The protective wall 43 used in the present embodiment is made of steel. The protective wall may be made of concrete. The protective wall 43 is set. Initially, the protective wall 43 is set to a position which comes under the lifting tool 59 when the jack type lifting machine 101 is moved onto the beam 40b. The protective wall 43 as a one-piece structure is connected to the lifting tool 59. The protective wall 43 is moved above the temporary opening portion 17 using the jack type lifting machine 101 according to the procedure similar to that when the shutter 18 is moved. Next, the protective wall is lowered down into the inner wall surface of the reactor well 5 using the jack type lifting device 50. Next, the buffer member 43b is attached onto the inside of the protective wall 43, and the protective wall supporting members 43a are attached to the outside of the protective wall 43. In the present embodiment, the buffer member 43b and the protective wall supporting members 43a are carried in the reactor building 3 through the large article carrying-in port, not shown, provided in the reactor building 3. By providing the buffer member 43b and the protective wall supporting members 43a, the RPV can be supported by the protective wall 43 even if the RPV 1 falls toward the side of the protective wall 43.

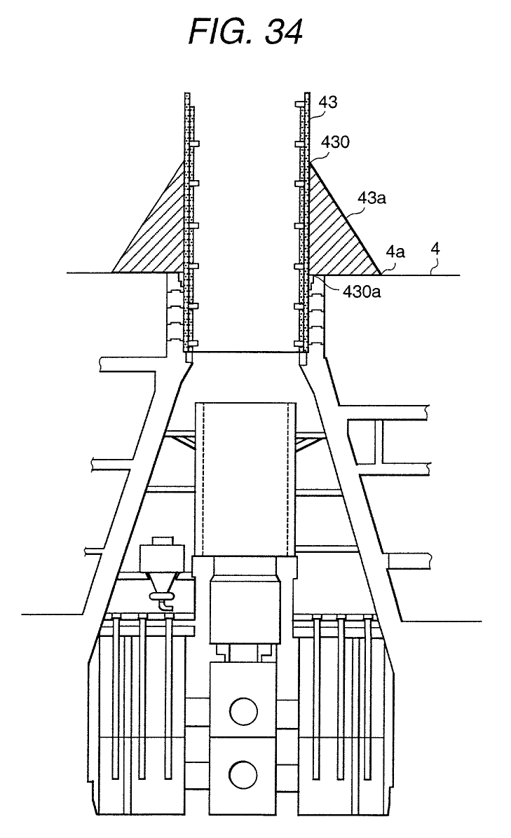

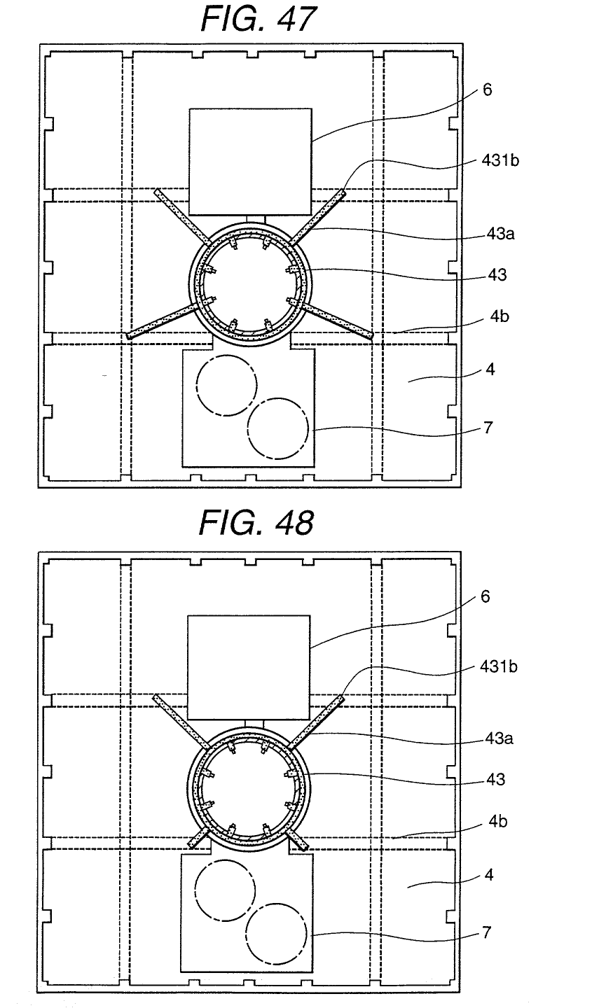

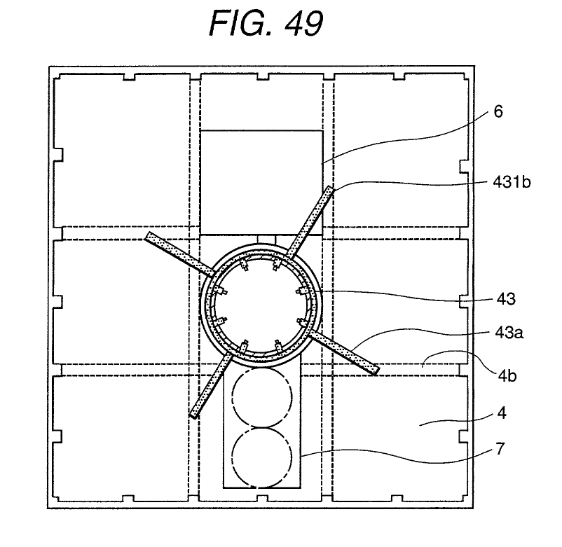

Each of the protective wall supporting members 43a is column-shaped, and the protective wall supporting members 43a are arranged around the outside of the protective wall 43 radially with respect to the center of the protective wall 43, and the upper ends 431a of the protective wall supporting members 43a are fixed to arbitrary positions on the protective wall 43 in the height direction of the protective wall 43. As shown in FIG. 47, the lower ends 431b of the protective wall supporting member 43a are fixed onto positions on the operating floor which are located just above reinforcing members 4b such as beams and columns of the floor under the operating floor. In FIG. 47, the space between the supporting members 43a is set so that each of the lower ends 431b of the supporting members 43a may be positioned at positions on the operating floor just above the reinforcing member 4b. In FIG. 48, the supporting members 43a are equally spaced, and a length of each of the supporting members 43a is adjusted so that each of the lower ends 431b of the supporting members 43a may be positioned at a place on the operating floor just above the reinforcing member 4b. FIG. 49 shows the arrangement of the supporting members 43a in a plant of which shapes of the spent fuel pool 6 and the component pool 7 are different from those in the other examples described above, and the arrangement of the reinforcing members 4b is also different. The supporting members 43a have an equal length, and are attached to the protective wall 43 in an equal attached angle, and arranged equally spaced between the supporting members 43a. The supporting members 43a are positioned by changing the setting position to rotate the supporting members 43a with respect to the center of the protective wall 43 so that the lower ends 431b of the supporting members 43a come at set positions just above the reinforcing members 4b. Further, as shown in FIG. 34, the protective wall supporting member 43a may be a triangular plate of which the shape is formed by connecting an arbitrary point 430 in the height direction of the protective wall 43 and an arbitrary point 4a on the operating floor 4 and a point 430a on the boundary between the protective wall 43 and the operating floor 4.

By setting the guide 44 inside the protective wall 43, the RPV 1 is prevented from swinging when the RPV 1 is carried out or carried in, and accordingly the RPV 1 can be carried out or carried in under a stable lifting condition. The guides 44 are arranged on the periphery of the inner surface of the protective wall 43 with an equal spacing or an appropriate spacing. FIG. 17 shows the example in which eight lines of the guides 44 are arranged on the inner surface of the protective wall 43. However, number of the arranged lines of the guides 44 is not limited to the number in the example, and the sufficient number of the arranged lines of the guides 44 is at least three or more. Further, the guides 44 are vertically arranged from the upper end to the lower end of the protective wall 43 with an equal spacing or an appropriate spacing. The spacing between the upper and the lower guides 44 is set to a space small enough not cause interference between the guide bracket 44a and the RPV 1 by entering of the top end portion or the bottom end portion of the RPV 1 between the guides 44 vertically adjacent to each other.

The guides 44 not only have the function that when the RPV 1 is being carried in or out, the posture of the RPV 1 is stabilized, but also have the function that if the RPV 1 drops down when the RPV 1 is being carried in or out, the posture of the dropping RPV 1 is maintained so that the central axis in the longitudinal direction of the RPV 1 may become nearly vertical to make the RPV 1 drop down onto the top surface of the pedestal 10 through the inside of the protective wall.

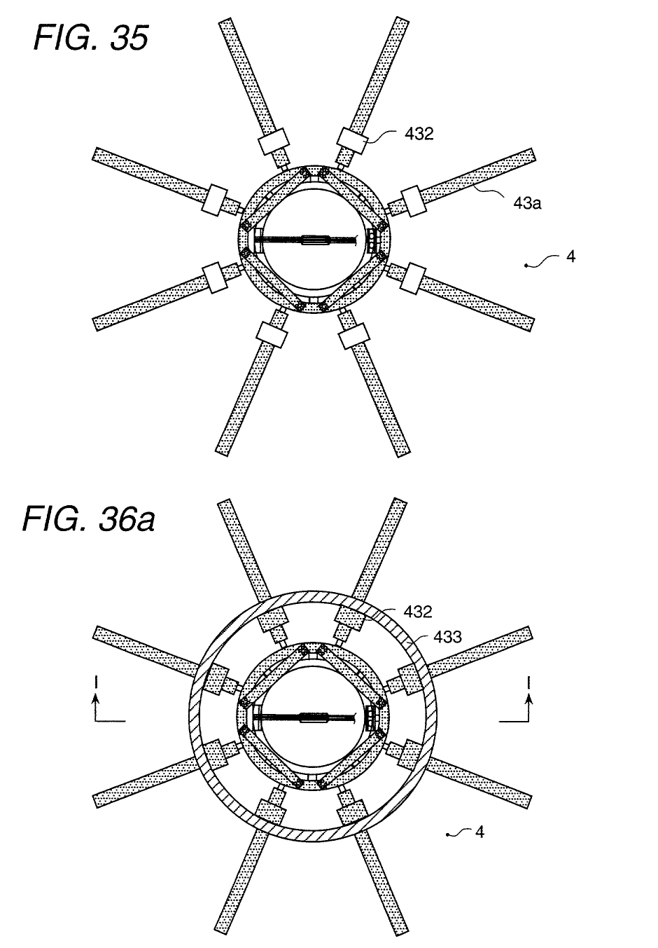

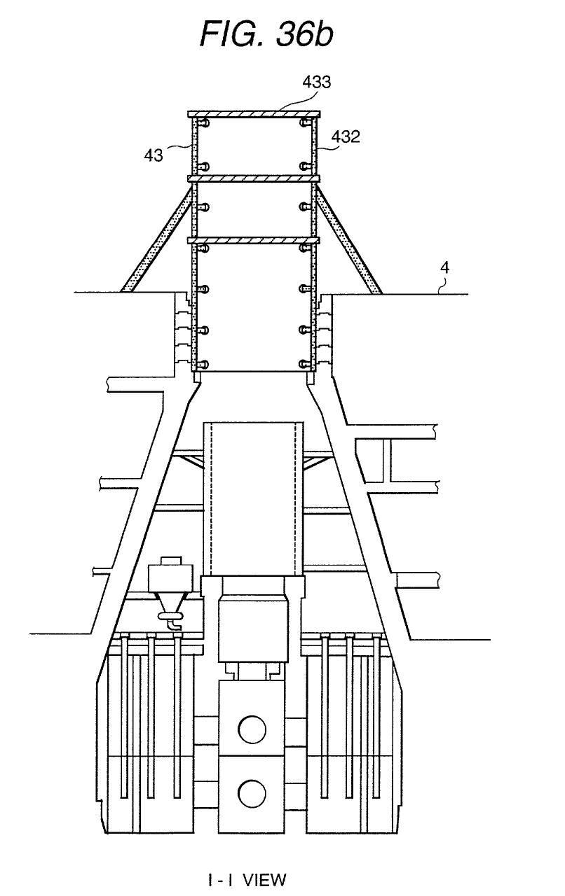

In an event of dropping-down of the RPV 1, the function of the protective wall 43 is sufficient if the protective wall 43 can protect the facilities and the components around the protective wall 43 by preventing the RPV 1 from spring out of the protective wall 43 to make the RPV 1 drop down onto the top surface of the pedestal 10. Therefore, the structure of the protective wall 43 is not necessary to cover the whole circumference around the RPV 1, and accordingly, the protective wall may be of a structure formed of only columns. FIG. 35 is a plan view of a protective wall 43 of a column structure seeing from the top side. The columns 432 are arranged on the circumference of a circle around the RPV 1 with an equal spacing or an appropriate spacing, and each of the columns 432 is supported on the operating floor 4 by an individual protective wall supporting member 43a. FIG. 35 shows an example in which eight of the columns 432 are arranged around the RPV 1. However, number of the arranged columns 432 is not limited to the number in the example, and the sufficient number of the arranged columns 432 is at least three or more. Further, as shown in FIG. 36a and FIG. 36b, the strength of the protective wall 43 can be increased by surrounding around the columns 432 with a reinforcing member 433 for reinforcing the columns 432, if necessary. Arbitrary number of the reinforcing members 433 may be arranged at arbitrary positions between the upper end of the protective wall 43 and the operating floor 4. It is preferable that the reinforcing members 433 are arranged with an equal spacing or an appropriate spacing, if possible.

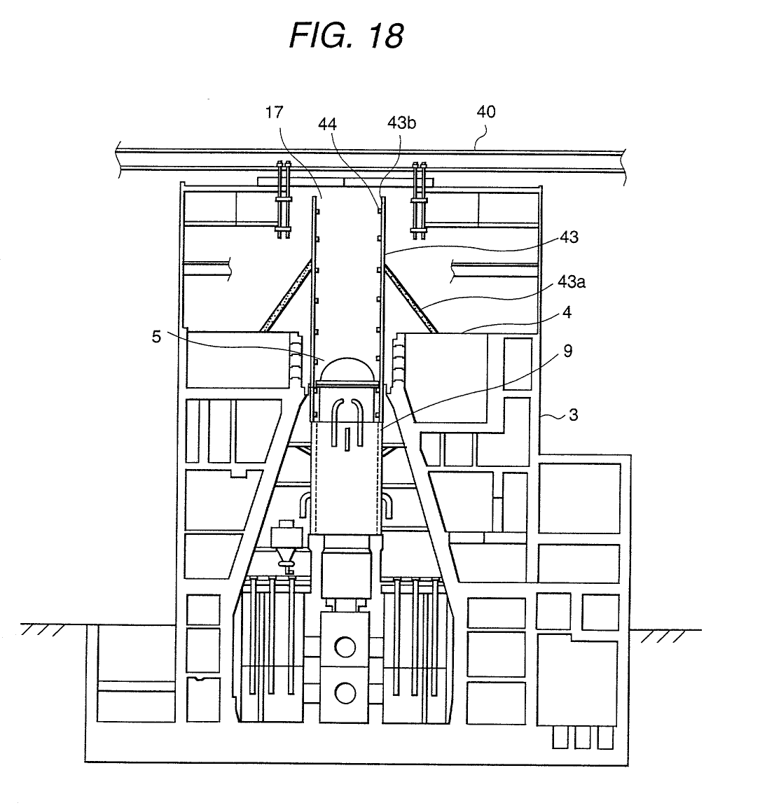

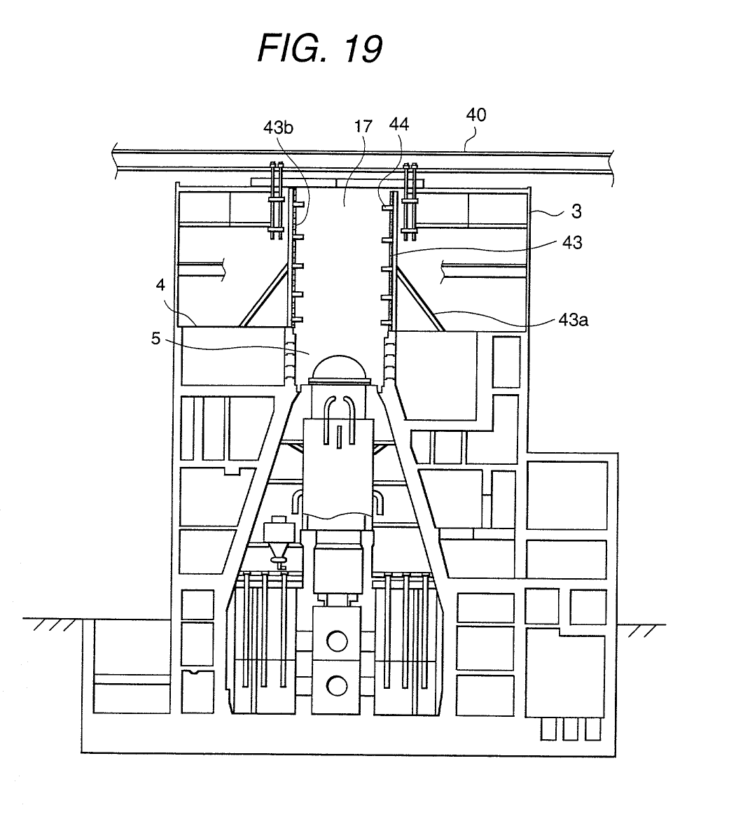

There, the protective wall 43 may be set on the operating floor 4 or on the RSW 9 around the reactor well 5. FIG. 18 shows the situation that the protective wall is set in an upper portion of the reactor shielding wall. The guide 44 and the buffer member 43b are attached inside the protective wall. FIG. 19 shows the situation that the protective wall is set on the operating floor around the reactor well. The guide 44 and the buffer member 43b are also attached inside the protective wall. By connecting the protective wall 43 to the beam frame 40 to support a part of load acting on the beam frame 40 by the protective wall 43, the members of the beam frame 40 can be reduced in size.

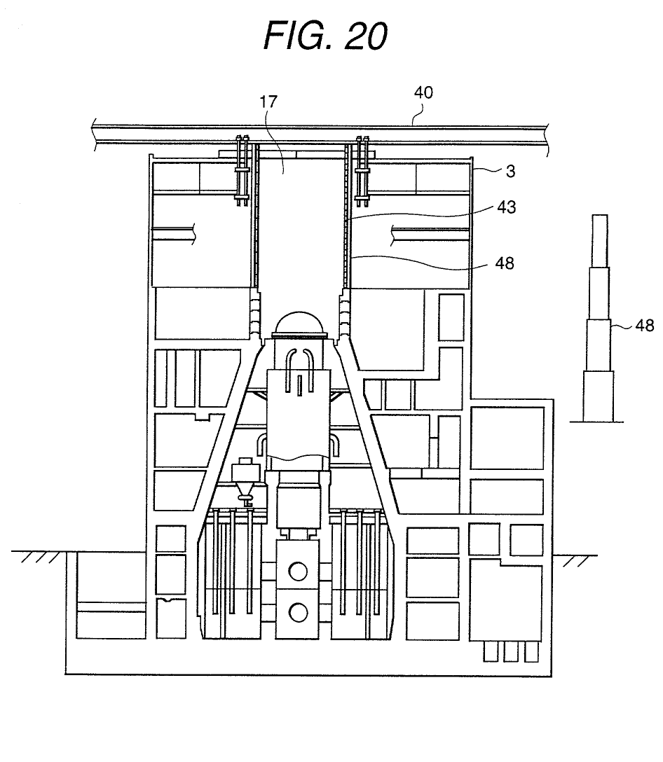

FIG. 20 shows the situation that an expandable telescopic structure (a hydraulic jack or the like) also serving as a protective wall is set on the operating floor around the reactor well. The protective wall 43 is composed of the expandable telescopic structure 48 (the hydraulic jacks or the like). According to this structure, the expandable telescopic structure is employed for the protective wall, and the load acting on the beam frame 40 is similarly supported by the protective wall 43. Therefore, the members of the beam frame 40 can be reduced in size, and can be set and removed in a short time.

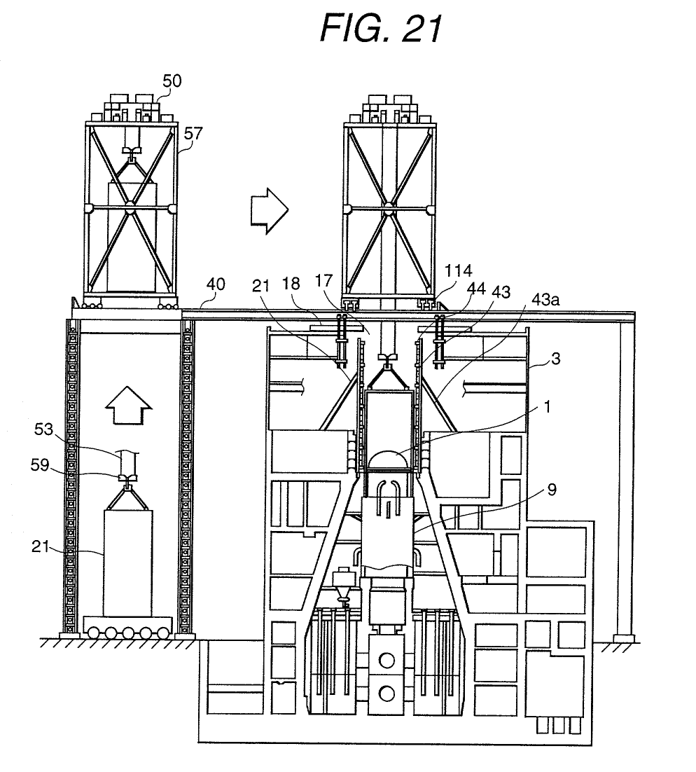

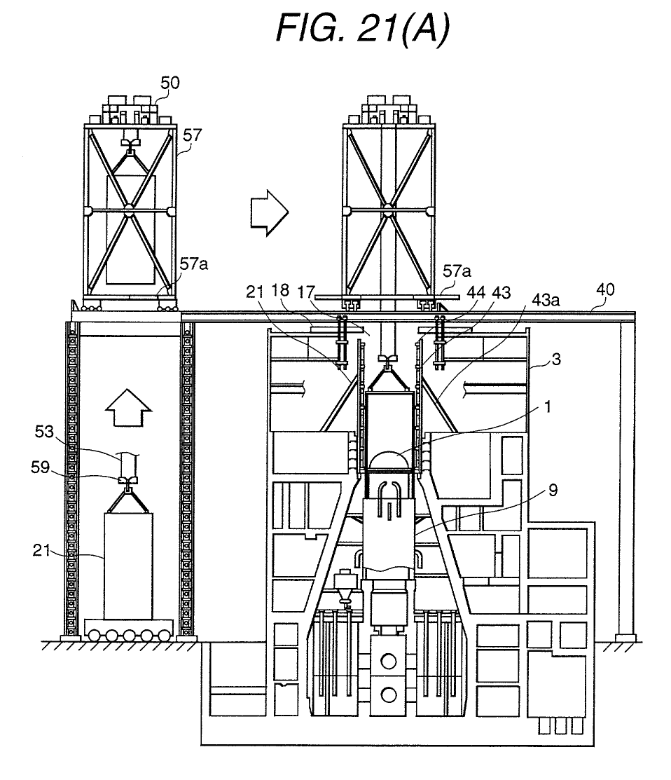

In Step S7, the RPV temporary radiation shield is carried in the reactor building, and is set in the upper portion of the RSW. FIG. 21 shows the state that the RPV shield body 21 is set in the upper portion of the reactor shielding wall 9. The RPV temporary radiation shield 21 is for shielding radioactive rays from the activated RPV 1, and made of iron in the present embodiment. In the case where the reactor temporary radiation shield is made of iron, it becomes a structure having its thickness of 150 to 200 mm and its weight of 400 to 500 tons.

The RPV temporary radiation shield 21 is set according to the procedure similar to that of the shutter 18. The RPV temporary radiation shield 21 is lifted up from the ground onto the beam frame 40 using the jack type lifting machine 101, and then moved above the temporary opening portion 17. Using the jack type lifting device 50 of the jack type lifting machine 101, the RPV temporary radiation shield 21 is moved through the temporary opening portion 17 and the inside of the protective wall 43 and guided by the guide 44, and temporarily placed on the upper portion of the RSW 9. When the RPV temporary radiation shield 21 is moved through the temporary opening portion 17 and the inside of the protective wall 43 and placed on the upper portion of the RSW 9, the traveling device 58 is fixed to the beam frame 40 with pins 114. The fixing of the traveling device 58 to the beam frame 40 using the pins 114 may be employed in the case of setting the shutter 18 or the protective wall 43.

Although the traveling device 58 described above is a traveling device for traveling on the beam frame 40, a traveling device 58a capable of preventing the traveling device from falling down may be used instead of the traveling device 58. FIG. 30 shows the traveling device 58a. The traveling device 58a has upper wheels 250 and lower wheels 251. The upper wheels 250 and the lower wheels 251 are attached to the traveling device 58a so as to put the beam frame 40 between the upper wheels 250 and the lower wheels 251. Thereby, even if a force acts on the traveling device 58a from its upper portion in a direction to depart the traveling device 58 from the beam frame 40 due to an earthquake or the like, the lower wheels 251 will be caught by the beam frame 40. Therefore, the carriage 57 can be prevented from falling down. Further, the carriage 57 can be prevented from falling down due to strong wind or the like.

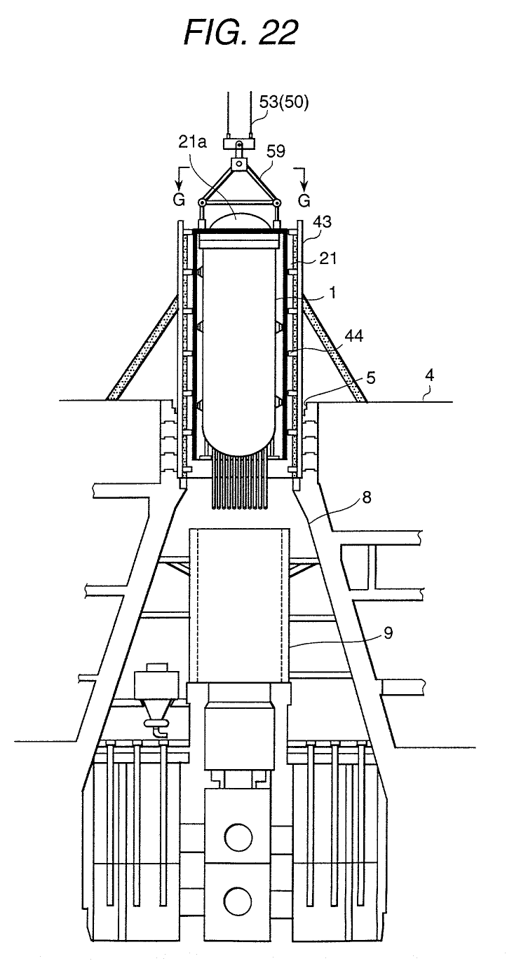

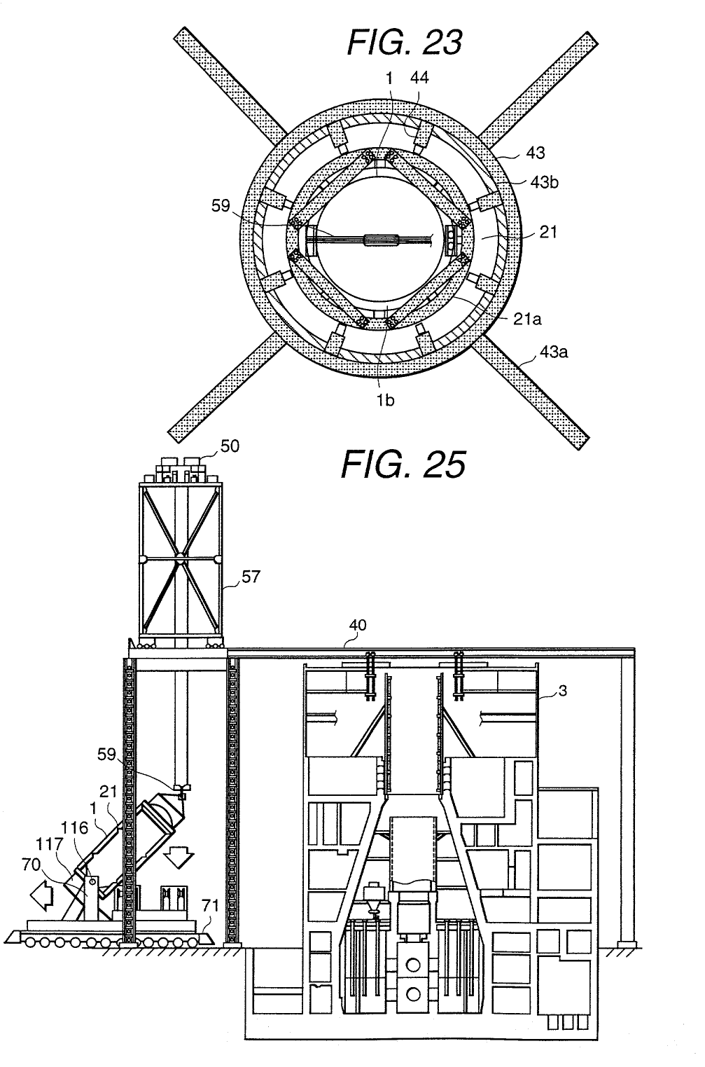

In Step S8, the RPV 1 together with the temporary radiation shield is lifted up to be carried out from the reactor building. FIG. 22 is a cross-sectional view showing the reactor building in the state that the RPV 1 is lifted up by the rods 53 of the jack type lifting device 50, and the upper portion of the RPV 1 is in contact with the bottom surface of the upper portion of the RPV temporary radiation shield 21. FIG. 23 is a view seeing from the arrow G-G of FIG. 22. Beams 21a attached to the top portion of the RPV temporary radiation shield 21 are placed at plural positions in the peripheral direction of the RPV. The procedure of carrying the RPV and the temporary radiation shield together out of the reactor building will be described below. At the time of completion of the work of Step S7, the lifting tool 59 is inside the reactor building 3. The connection between the lifting tool 59 and the RPV temporary radiation shield 21 is taken off, and the lifting tool 59 is lowered down to the upper end portion of the RPV 1 using the jack type lifting device 50. The lifting tool 59 is connected to the flange 1b of the RPV 1. The lifting tool 59 and the RPV1 are lifted up by operating the jack type lifting device 50. Further, the lifting tool 59 and the RPV1 are lifted up to bring the lifting tool 59 in contact with the upper surface of the flange 1b of the RPV 1 (here, the “bring in contact with” means “hook”).

The beams 21a are attached to the top portion of the RPV temporary radiation shield 21 as shown in FIG. 23. That is, the beams 21a are arranged so as to come over the flange 1b of the RPV 1 when seeing from the upside. By doing so, when the RPV 1 is moved from the downside to the upside inside the temporary radiation shield 21, the flange 1b is caught on the beams 21a to lift up the RPV 1 and the temporary radiation shield 21 together. There, when the RPV 1 and the temporary radiation shield 21 are carried out together, it is assumed that the RPV 1 drops down into the reactor well 5 due to some cause. In this case, the RPV 1 drops together with the temporary radiation shield 21. However, since the temporary radiation shield 21 has an outer size larger than the inner diameter of the RSW 9 and is in contact with the RPV 1, the temporary radiation shield 21 landing onto the upper portion of the pedestal 10. The landed RPV 1 is prevented from falling toward the spent fuel pool 6 side by the RSW 9. As described above, by bring the RPV in contact with the temporary radiation shield, the RPV 1 is prevented from damaging the spent fuel pool 6.

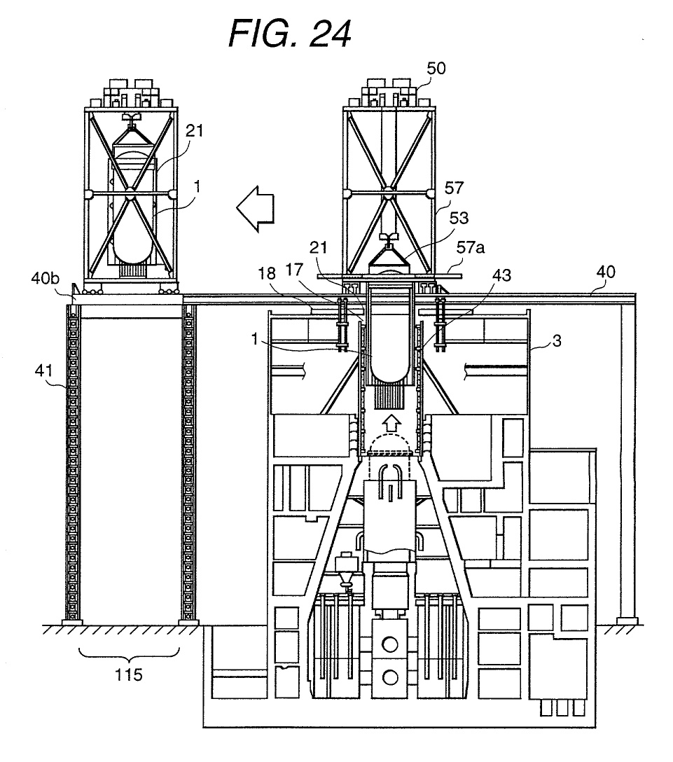

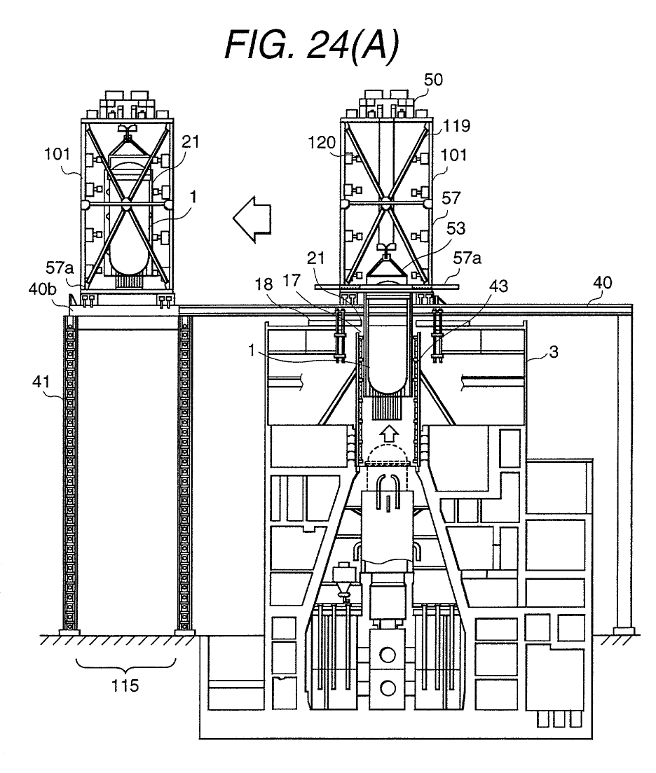

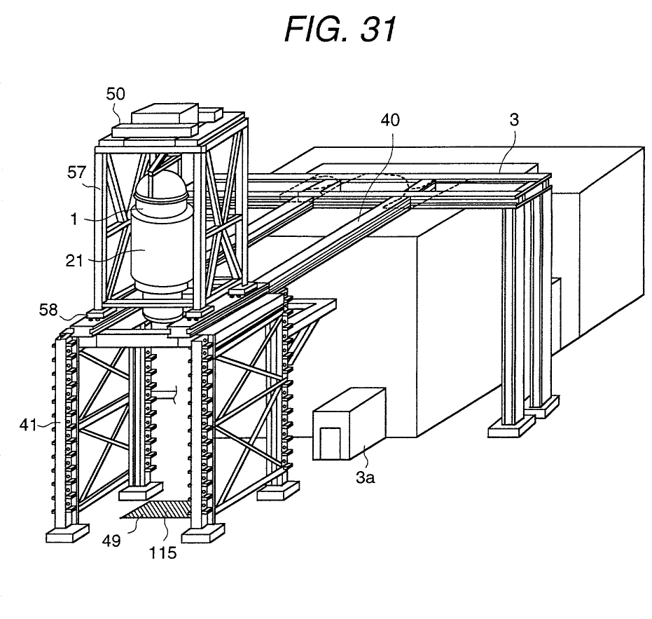

Next, the RPV 1 and the temporary radiation shield 21 are further lifted up together using the jack type lifting device 50 (FIG. 24), and the lowermost portion of the equipments attached to the RPV 1 is brought up to a level higher than the upper surface of the reactor building 3 and the upper surface of the shutter 18. Then, the shutter 18 is closed. The pins 114 are removed, and the jack type lifting machine 101 is moved onto the beam 40b (to a position above the RPV lifting-down position 115) using the traveling device. FIG. 31 is a perspective view showing the state that the jack type lifting machine 101 hanging the RPV 1 exists on the beam 40b.

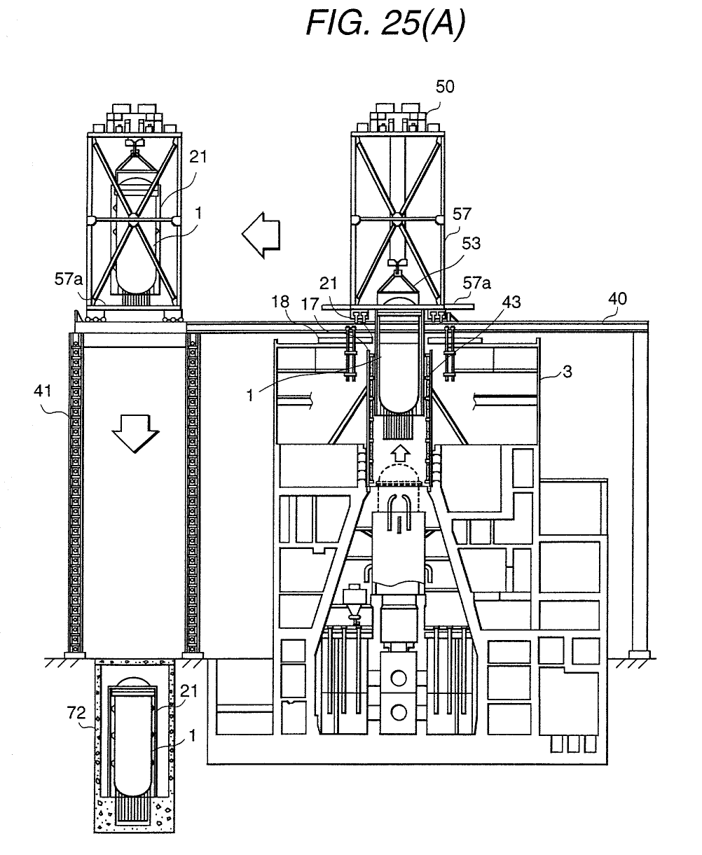

A trailer 71 mounting a turnover carriage 70 for putting over the RPV 1 on its side is arranged at the RPV lifting-down position 115, and the RPV 1 and the temporary radiation shield 21 is lowered to an RPV support 117 of the turnover carriage 70. The RPV support 117 is rotatable around a hub 116. The RPV 1 and the temporary radiation shield 21 are further lowered using the jack type lifting device while the trailer 71 is being moved in the direction departing from the reactor building 3. By doing so, as shown in FIG. 25, the RPV 1 and the temporary radiation shield 21 are gradually laid around the hub 116, and finally, are horizontally mounted on the trailer 71. The connection between the lifting tool 59 and the RPV 1 is taken off, and the RPV 1 and the temporary radiation shield 21 are transported to a storing place using the trailer. Thus, the carrying-out of the used RPV 1 is completed.

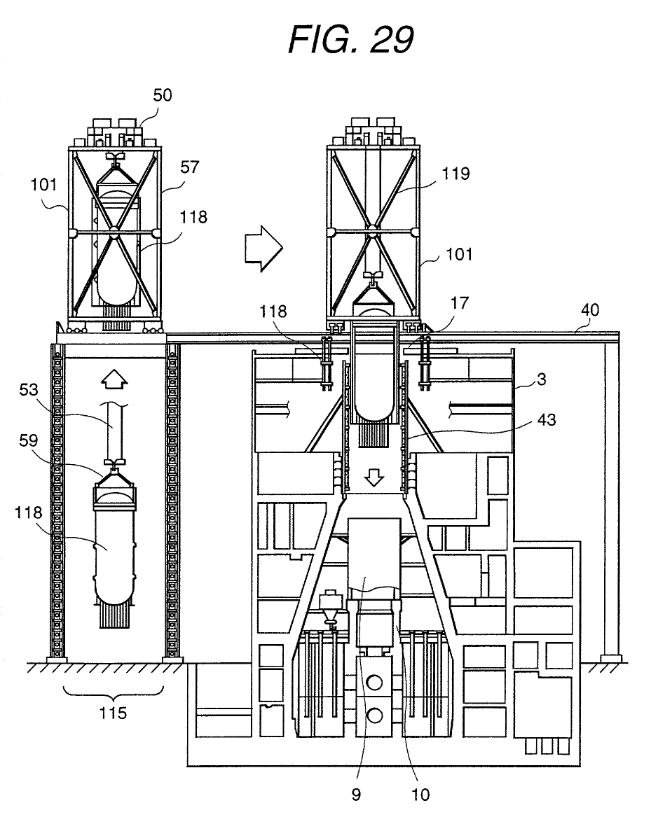

In Step S9, as shown in FIG. 29, a new RPV 118 is lifted up, and carried into the reactor building, and then set on the pedestal 10. The carrying-in of the new RPV 118 is performed according to the procedure inverse to the procedure of carrying-out the RPV 1 out of the reactor building 3, except that the new RPV has no temporary radiation shield. That is, the new RPV 118 is transported to the RPV lifting-down position 115 by the trailer, and the lifting tool 59 is connected to the new RPV 118, and the new RPV 118 is erected upright around the hub 116 by lifting upward the lifting tool 59 while the trailer is being moved toward the building 3. After that, the lifting tool 59 is lifted to bring the lowermost surface of the new RPV 118 higher than the shutter 18, and the carriage 57 is moved on the beam frame 40 to bring the center of the new RPV 118 to a position just above the center of the position where the new RPV 118 is to be installed (that is, the same position in the vertical direction).

The guide bracket 44a of the protective wall 43 is operated to set the position of the guide bracket 44a to the position for guiding the new RPV 118, and the lifting tool is lowered using the jack type lifting device 50 to put the new RPV 118 on the upper portion of the pedestal 10 through the inside of the RSW 9, and then the new RPV 118 is fixed to the pedestal similarly to the RPV 1. Thus, even if the new RPV 118 drops inside the reactor well due to some cause when the new RPV 118 is carried into the reactor building 3, the new RPV 118 will be landed onto the upper portion of the pedestal 10 through the inside of the RSW 9 by the protective wall 43 and the guide 44. Accordingly, the protective wall 43, the guide 44 and the RSW 9 can prevent the new RPV 118 from falling down around the protective wall 43 or the RSW 9. Therefore, it is possible to prevent the new RPV 118 from damaging the facilities and the components on the operating floor 4 such as the spent fuel pool 6 and the component pool 7.

In Step S10, the protective wall 43 and the support member 43a are removed and carried out of the reactor building 3. Since the removing of the protective wall and the support member 43a is performed according to the procedure inverse to that of setting the protective wall and the support member 43a, the explanation is omitted here. In Step S11, temporary opening portion 17 is restored and closed. The restoration is performed by transporting the removed roof 113 removed at setting the opening in Step S5 from the storing place, returning the removed roof to the temporary opening portion 17 according to the procedure inverse to the procedure at the removing, and restoring the joining portion between the removed roof and the reactor building roof by padding, bolting and poring of concrete. Although the removed roof is reused in the present embodiment, a new roof may be set to the temporary opening portion. In Step S03, the jack type lifting device 50 installed outside the reactor building is removed. Since the removing method is performed according to the procedure inverse to that of Step S02, the explanation is omitted here. Next, in Step S04, the beam frame is disassembled. Since the removing method is performed according to the procedure inverse to that of Step S02, the explanation is omitted here.

Next, in Step S12, all the pipes connected to the new RPV 118 are restored, and in Step S13, all the fuel assemblies 11 of the spent fuel pool are loaded in the core. Next, in Step S14, the nuclear reactor is paralleled and started operation.

The work of Step S03 and Step S04 described above may be performed during performing the work of Step S12 to Step S14. Otherwise, the work of Step S03 and Step S04 may be performed after the work of Step S14, that is, after starting operation of the nuclear reactor. By performing at least a part of the work of Step S03 and Step S04 after starting the work of Step S12, the work period can be shortened. Thereby, the radiation exposure of the workers can be reduced. Further, since the shutdown period of the nuclear power plant can be shortened, operation of the nuclear power plant can be restarted earlier. Accordingly, the availability of the nuclear power plant can be improved. Thus, the series of RPV replacing work is completed.

According to the present embodiment, since the beam frames are constructed above the roof of the reactor building to move the lifting machine 101 on the beam frames, it is possible to make swing of the RPV smaller compared to swing of the RPV when the RPV is moved using a crane. Further, the probability of falling down of the machine for lifting the RPV can be lowered compared to the probability when the RPV is moved using a crane. Thereby, the probability of dropping of the RPV can be excluded. Therefore, the dangerousness in regard to moving the RPV can be reduced, and accordingly cost such as insurance cost for insuring the work can be reduced. Further, by using the jack type lifting device 50, the dangerousness of dropping-down of the lifted object can be excluded compared to the dangerousness of dropping-down of the lifted object caused by break of a wire when the lifted object is lifted using the wire. Further, even if the RPV 1 drops down, dropping of the RPV can be limited only on the pedestal by providing the protective wall. That is, the provision of the protective wall can prevent the incident that the RPV falls down on the operating floor and falls toward the spent fuel pool side to break the spent fuel pool and to damage the fuel assemblies stored in the spent fuel pool, or the incident that the RPV falls down on the operating floor and falls toward the component pool side to break the component pool and to damage the components stored in the component pool, or the incident that the RPV falls down on the operating floor and rolls on the operating floor to damage the components placed on the operating floor.

(Embodiment 2)

As another embodiment in accordance with the present invention, description will be made below on an embodiment in which the beam frames are set through another method when the RPV is replaced. The present embodiment is different from the Embodiment 1 in the work of Step S01. Since the work of the other steps is the same as that in Embodiment 1, the explanation of the work of the other steps is omitted here.

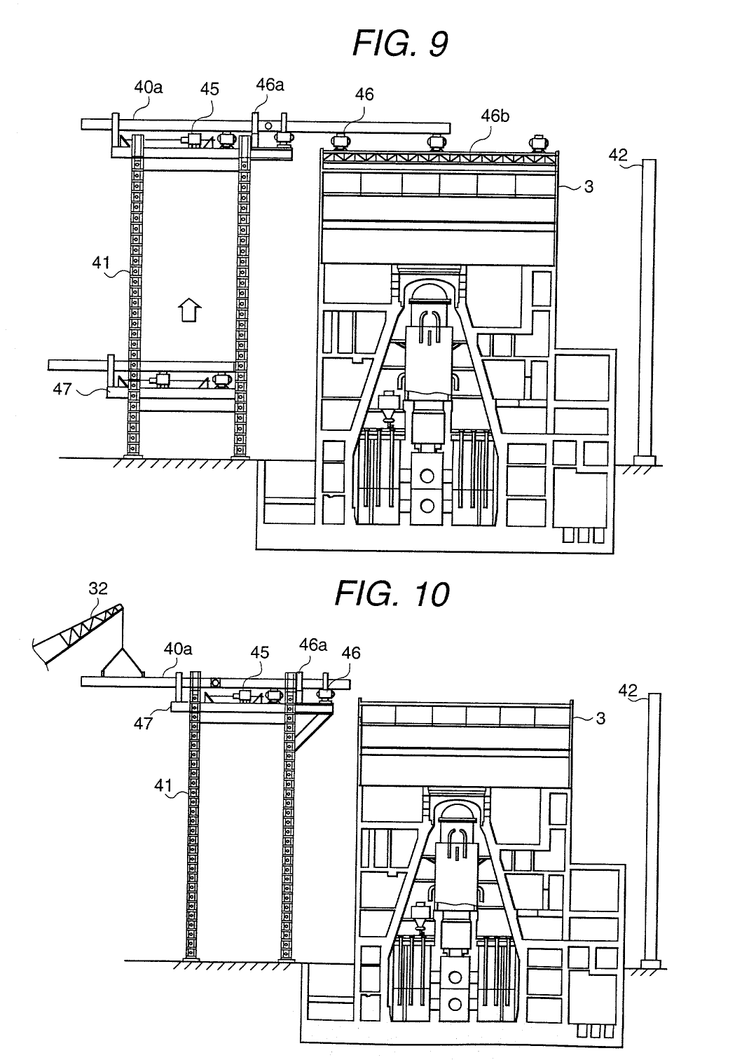

Almost parts of the work of Step S01 in the present embodiment are similar to those of Embodiment 1. Here, only a different point will be described. Description will be made on a method of feeding the beam frames 40 when the beam frames 40 are set above the roof of the reactor building 3. The jack hoisting columns 41 are erected, and the beams 40a transported up to the upper portion of the jack hoisting column 41 using the jack type hoisting device 60 are fed toward the roof of the reactor building 3 using the beam frame feeding jack 45. At that time, as shown in FIG. 9, trusses 46b are initially set on the roof 112 of the reactor building 3. Then, rollers 46 are set on the trusses 46b. When the beam 40a is fed by the beam frame feeding jack 45, the beam 40a is fed using the rollers 46 as the guide. By doing so, since the beam 40a is vertically supported by the rollers 46, vibration of the beam 40a above the roof 112 can be made smaller compared to the case where the beam is not supported by the rollers. Therefore, the work time of the workers can be shortened because interrupted work time due to the vibration can be reduced by the structure.

(Embodiment 3)

As another embodiment in accordance with the present invention, description will be made below on an embodiment in which the beam frames are set through another method when the RPV is replaced. The present embodiment is different from Embodiment 1 in the work of Step S01. Since the work of the other steps is the same as that in the Embodiment 1, explanation of the work of the other steps is omitted here. Almost parts of the work of Step S01 in the present embodiment are similar to those of Embodiment 1. Here, only a different point will be described. When the beam frames 40 are set above the roof of the reactor building 3, the beams 40a are lifted up to the upper portion of the jack hoisting column using a crane.

The procedure of lifting a first beam 40a together with the beam frame feeding jack 45 up to the upper portion of the jack hoisting column 41 is the same as the procedure in Embodiment 1. Next, the beam 40a is fed toward the side of the roof 112 using the first beam frame feeding jack 45, as shown in FIG. 10, and then a second beam 40a′ is inserted into the beam support 46a in the side opposite to the first beam 40a on the roof 112 using a crane 32. Then, the beam 40a and the beam 40a′ are connected to each other with bolts and pads while the beams are being held by the beam support 46a. Next, the beam 40a and the beam 40a′ are fed toward the upper portion of the roof 112, and a third beam, not shown, is inserted into the beam support 46a similarly to the beam 40a′ using the crane to be connected to the beam 40a′. According to the procedure described above, the beam frame 40 is placed above the roof 112.

According to the present embodiment, since the beam frame can be transported up to the level of the reactor building by the crane, the beam frame can be transported in a shorter time compared to in the case of using the jack type hoisting device. Thereby, since the time required for setting the beam frame can be shortened, the work time of the workers can be shortened.

(Embodiment 4)

As another embodiment in accordance with the present invention, description will be made below on an embodiment in which an openable door 57a is arranged under the jack type lifting machine 101 used at replacing the RPV, and further a guide 120 is provided inside the carriage 57. The present embodiment is different from Embodiment 1 in the jack type lifting machine 101, but the work of each of the steps is the same as that of Embodiment 1. Therefore, the description will be omitted here. The guide 120 has the same structure of the guide 44. The jack type lifting machine 101 has the jack type lifting device 50 on the top portion of the carriage 57.

The jack type lifting machine 101 used in the present embodiment has the openable door 57a in the lower portion, that is, in the bottom portion of the carriage 57. By providing the openable door 57a, the openable door 57a prevents the RPV from dropping down under the carriage 57 even if the RPV lifted by the lifting tool 59 drops due to some cause when the RPV is held inside the carriage 57. The openable door 57 is opened when the RPV is lifted up or lifted down by the jack type lifting machine 101, and is closed in the other time. Further, the strength of the trusses 119 provided in the side faces of the carriage 57 is increased, and the space between the trusses is made narrower. Thereby, it is possible to prevent the lifted object from falling toward the outside of the carriage 57 even if the lifted object falls inside the carriage (falls against the trusses 119).

FIG. 24(A) shows the state that the RPV 1 is lifted up. This figure explains the work of Step 8 in detail. In Step 8, the temporary radiation shield 21 and the RPV 1 are connected to the lifting tool 59, and the openable door 57a is opened when the temporary radiation shield 21 and the RPV 1 are lifted upward. By checking that the lowermost portion of the RPV 1 becomes higher than the upper surface of the openable door 57a, the openable door 57a is closed. Next, the jack type lifting machine 101 is moved on the beam frame 40, and the openable door 57a is opened again when the temporary radiation shield 21 and the RPV 1 are lifted down. Opening and closing of the openable door 57a at carrying in the temporary radiation shield and the new RPV is performed according to the procedure inverse to the procedure at carrying out the RPV. By providing the openable door 57a as described above, an object lifted inside the carriage can be prevented from dropping down under the carriage when the door is closed. By providing the guide 120, lifting of the RPV can be performed stably, and further the RPV 1 can be prevented from swinging when the jack type lifting machine 101 is moved.

(Embodiment 5)

As another embodiment in accordance with the present invention, description will be made below on an embodiment in which the RPV is stored in a storage building provided at a level under the jack hoisting columns when the RPV is replaced. The present embodiment is different from the Embodiment 1 in the work of Step S8. Since the work of the other steps is the same as that in Embodiment 1, the explanation of the work of the other steps is omitted here. Almost parts of the work of Step S8 in the present embodiment are similar to those of Embodiment 1. Here, only a different point will be described. The jack type lifting machine 101 has the jack type lifting device 50 on the top portion of the carriage 57.

After lifting the RPV 1 and the temporary radiation shield 21 inside the carriage 57, the pins 114 is removed, and the carriage 57 is moved on the beams 40b (to the place above the RPV lifting-down position 115) using the traveling device 58. FIG. 24 show the state that the RPV 1 is lifted up by the jack type lifting device, and is being carried out from the reactor building 3. As shown in FIG. 25(A), a storage building cover 72a of the storage building 72 arranged under the RPV lifting-down position 115 is opened. The RPV 1 and the temporary radiation shield 21 are lowered in the storage building 72 using the jack type lifting device 50. Next, the connection between the lifting tool 59 and the RPV 1 is detached. Then, the storage building cover 57a is closed. Thus, the carrying-out of the used RPV 1 is completed.

According to the present embodiment, by storing the RPV in the storage building provided under the lifting-down position of the jack type lifting machine 101, there is no need to transport the RPV using the trailer. Therefore, it is not necessary to perform the work of driving the trailer, compared to the case of transporting the used RPV to the other storing place using the trailer. Further, it is not necessary to perform the work of unloading the RPV from the trailer at the storing place, the unloading work being required in the case of transporting the used RPV to the other storing place using the trailer. Thereby, the time required for transporting the RPV using the trailer and for unloading the RPV from the trailer can be eliminated. Accordingly, the total man-hours required for the RPV replacement can be reduced. Therefore, operation of the nuclear power plant can be restarted earlier. Thereby, the availability of the nuclear power plant can be improved compared to the case of transporting the RPV to the storing place using the trailer. Further, the radiation exposure of the workers during transporting the RPV using the trailer and during unloading the RPV from the trailer can be eliminated.

(Embodiment 6)

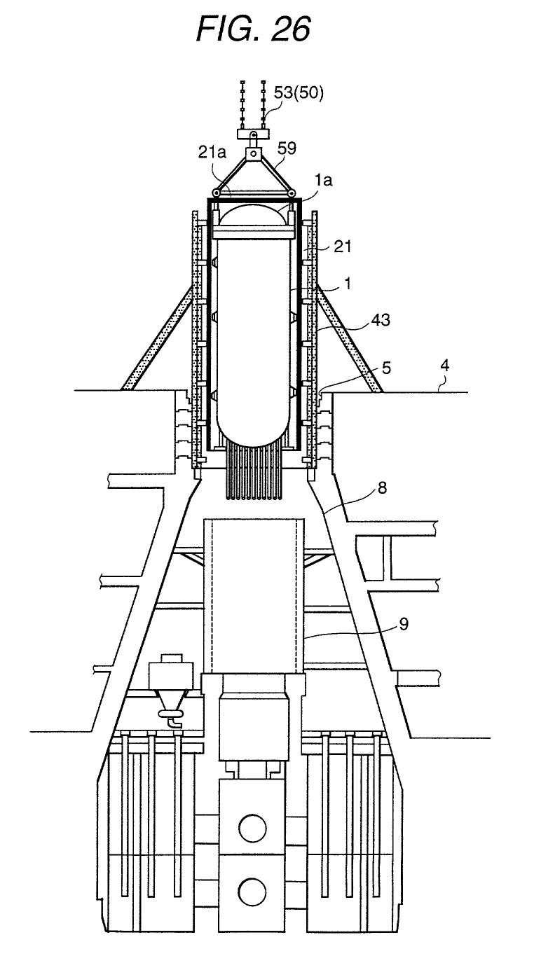

As another embodiment in accordance with the present invention, description will be made below on an embodiment in which the temporary radiation shield and the RPV are in contact with each other at the top end portion. The present embodiment is different from Embodiment 1 in the method of attaching the temporary radiation shield 21. Since the work of the other steps is the same as that in the Embodiment 1, the explanation of the work of the other steps is omitted here. As shown in FIG. 26, the gap between the beams 21a arranged in the upper surface of the temporary radiation shield is set narrower than that in Embodiment 1, and the beams 21a are in contact with the top head 1a of the RPV 1. Further, the vertical length of the temporary radiation shield 21 is made longer than the total height of the RPV 1. Since the method of lifting up the temporary radiation shield 21 and the RPV 1 together is the same as that in Embodiment 1, the explanation is omitted here.

According to the present embodiment, since the temporary radiation shield can cover the whole RPV, the radioactive rays from the RPV can be shielded more than the case of not covering the whole RPV with the temporary radiation shield. Thereby, the radiation exposure of the workers engaging in the RPV replacement can be reduced.

(Embodiment 7)

As another embodiment in accordance with the present invention, description will be made below on an embodiment in which the temporary radiation shield and the RPV are in contact with each other at the top end portion. The present embodiment is different from Embodiment 1 in the method of attaching the temporary radiation shield 21. Since the work of the other steps is the same as that in the Embodiment 1, the explanation of the work of the other steps is omitted here.

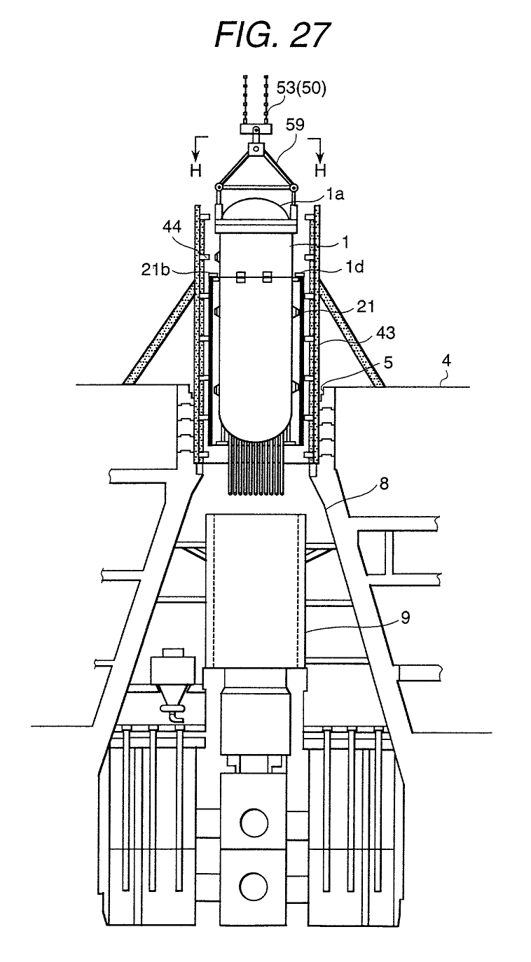

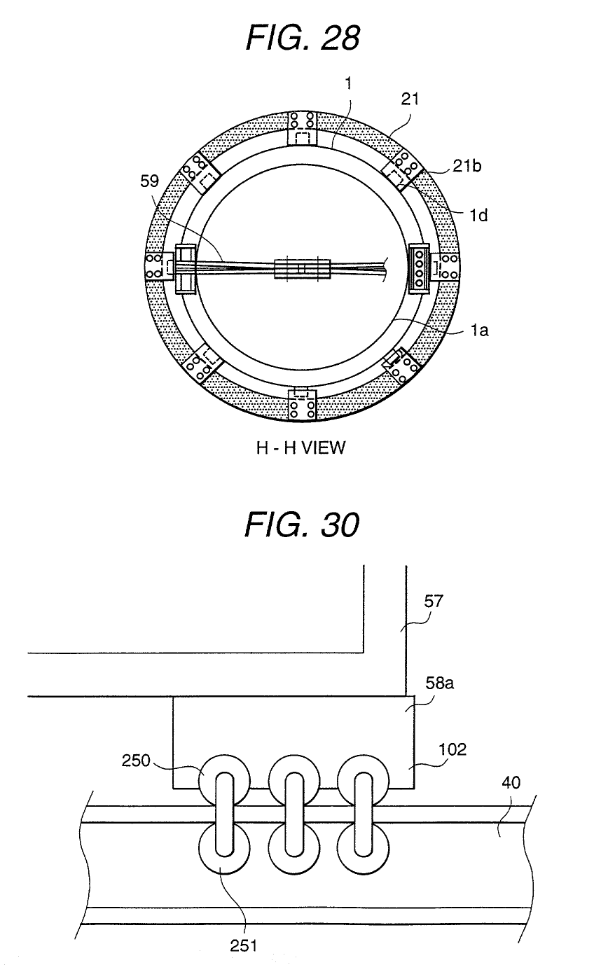

In the present embodiment, as shown in FIG. 27, a stabilizer lug 1d of the RPV 1 is contacted with the upper portion of the RPV temporary radiation shield 21, and the RPV and the RPV temporary radiation shield are lifted together. FIG. 28 is a view seeing from the arrow H-h of FIG. 27. A bracket 21b is provided so that the stabilizer lug 1d of the RPV 1 is contacted with the upper portion of the RPV temporary radiation shield 21. Since the method of lifting up the temporary radiation shield 21 and the RPV 1 together is the same as that in Embodiment 1, the explanation is omitted here.

According to the present embodiment, the size of the temporary radiation shield can be made smaller compared to the case where the temporary radiation shield covers the whole RPV. Thereby, the manufacturing cost of the temporary radiation shield can be reduced. Further, the weight of the temporary radiation shield can be reduced. Therefore, the lifting capacity of the jack type lifting device 50 for lifting the RPV and the temporary radiation shield together can be made smaller compared to the case where the temporary radiation shield covers the whole RPV. Therefore, the manufacturing cost of the lifting machine can be reduced. Further, the total work cost of the RPV replacement can be reduced.

Although in the present embodiment, the method of contacting the bracket 21b with the stabilizer lug 1d is employed, a method of connecting the bracket 21b and the stabilizer lug 1d with bolts may be employed. By connecting them with bolts, unexpected release of the connection between the RPV and the temporary radiation shield hardly occurs during the lofting process compared to the case of simply contacting the RPV with the temporary radiation shield. In this case, the strength of the bolt is determined as follows. Firstly, in regard to the strength of the bolts, the bolts need to be strong enough to lift up the RPV 1 and the RPV temporary radiation shield 21 together. Further, in assuming an event of the RPV dropping, the bolts should have such strength that the bolts are broken by an impact produced when the dropping temporary radiation shield 21 fits against the upper portion of the RSW. By setting the strength of the bolts as described above, the RPV 1 and the temporary radiation shield 21 are separated from each other when the RPV 1 drops down, and the RPV 1 drops down inside the RSW 9 to land onto the upper portion of the pedestal 10. Therefore, similarly to the case of contacting the bracket 21b with the stabilizer lug id, the RPV 1 remains inside the RSW 9, and accordingly the RPV 1 can be prevented from falling down around the RSW 9. Thus, it is possible to prevent the facilities and the components around the RSW 9 such as the spent fuel pool 6 and the component pool 7 from being damaged.

(Embodiment 8)

As another embodiment in accordance with the present invention, description will be made below on an embodiment in which the RPV is stored in a storage building arranged at a place other than the place under the jack hoisting column when the RPV is replaced. The present embodiment is different from Embodiment 1 in the work of Step S8. Since the work of the other steps is the same as that in the Embodiment 1, the explanation of the work of the other steps is omitted here. Almost parts of the work of Step S8 in the present embodiment are similar to those of Embodiment 1. Here, only a different point will be described.

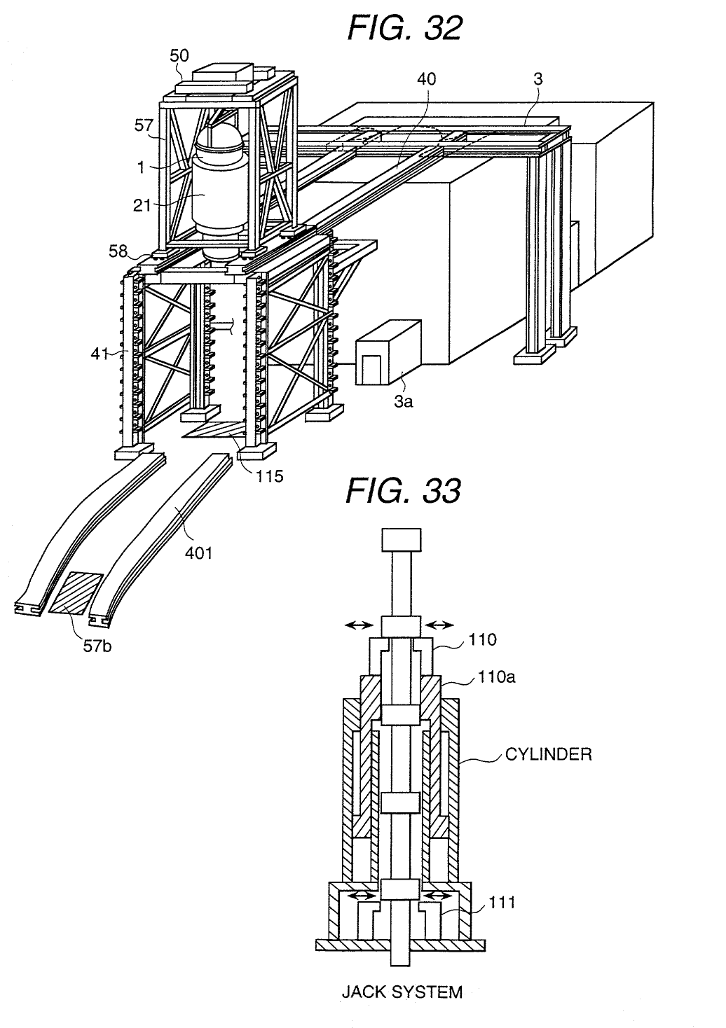

After lifting up the RPV 1 and the temporary radiation shield 21 inside the carriage 57, the pin 114 is removed, and the carriage 57 is moved on the beam 40b (to the place above the RPV lifting-down position 115) using the traveling device 58. FIG. 32 shows the state the RPV 1 is being carried out from the reactor building 3 using a jack type lifting device 50.

Next, the carriage 57 and the RPV 1 are lifted down to the RPV lifting-down position 115 together with the receiving beam 41b using the jack type hoisting device 60. By lifting down the carriage 57 and the RPV 1 together with the receiving beam 41b, the upper surface of the receiving beam 41b can be continuously connected to the upper surface of a transfer rail 401 installed on the ground. The carriage 57 is moved along the transfer rail 401 using the traveling device 58. Next, the storage building cover 57b is opened. The storage building, not shown, is arranged underground below the storage building cover 57b. When the vertical position of the RPV 1 is moved at a position within a range of storing the RPV 1 to the storage building 72 using the traveling device 58, the RPV 1 and the temporary radiation shield 21 are lifted down inside the storage building 72 using the jack type lifting device 50. The lifting tool 59 is removed from the RPV 1. The storage building cover 57b is closed. Thus, the carrying-out work of the used RPV 1 is completed.

According to the present embodiment, by moving the RPV to the storage building arranged at a position distant from the lifting-down position of the jack type lifting machine 101 using the transfer rail, the RPV does not need to be moved using any trailer. Therefore, compared to the case where the RPV is transported to the other storing place using the trailer, the present embodiment does not need to perform the work of operating the trailer. Further, the present embodiment does not need to perform the work of unloading the RPV from the trailer at the storing place which is necessary in the case where the RPV is transported using the trailer. Thereby, the time expended in transporting of the RPV using the trailer and in unloading of the RPV from the trailer can be eliminated. Thereby, the total man-hours expended for the RPV replacement can be reduced. Therefore, operation of the nuclear power plant can be restarted earlier. Thereby, the availability of the nuclear power plant can be improved compared to the case of transporting the RPV to the storing place using the trailer.

Further, by transferring the RPV on the transfer rail, the RPV can be stored in the storage building existing at the place distant from the reactor building. Thereby, the RPV can be carried out from the reactor building and stored in the storage building existing at the place distant from the reactor building without using any crane. Further, by curving the transfer rail, the RPV can be transferred even when there is an obstacle between the RPV lifting-down position and the RPV storage building.

Since there is no dangerousness of RPV dropping while the RPV is transferred on the ground, the RPV can be safely transferred. Further, the radiation exposure of the workers engaging in transportation of the RPV using the trailer and unloading of the RPV from the trailer can be eliminated.

According to the each of the embodiments described above, since the jack type lifting machine is used for carrying-out and carrying-in the RPV, swing of the RPV at carrying out the RPV from the reactor building and at carrying in the new RPV into the reactor building can be made smaller compared to the case where the RPV is transferred using a crane. Therefore, the reliability at transferring the RPV can be improved compared to the case of not using the jack type lifting machine.

Further, even if the RPV drops down due to some cause, the RPV can be prevented from falling toward the spent fuel pool to protect the spent fuel pool. Therefore, the safety of the RPV replacement work can be further improved.

Further, the assembling and disassembling work of the jack type lifting machine 101 is simpler than the assembling and disassembling work of a crane. Therefore, the time required for studying the work method can be reduced. Further, the time expended in the RPV replacing work can be shortened. Therefore, the nuclear power plant can be restarted earlier. Further, the assembling and disassembling work of the jack type lifting machine 101 is easy, and the installation area required for operating the jack type lifting machine and the site area required for assembling the jack type lifting machine can be made smaller than those in the case of using a crane.

Further, since the high safety of the spent fuel pool can be secured, the fuel assemblies in the spent fuel pool need not to be transferred outside the reactor building. Accordingly, the time relating to transferring the fuel assemblies can be eliminated. Therefore, the plant shutdown period associated with the RPV replacing work or the core internal replacing work of the nuclear power plant can be shortened. Thus, the availability of the nuclear power plant can be improved.

Although the embodiments described above have been explained by taking the RPV replacing work as examples, the same effects can be attained in work of replacing a core internal such as a core shroud or the like.

(Embodiment 9)

As another embodiment in accordance with the present invention, description will be made below on an embodiment in which a rod-shaped guide formed of rod-shaped members is attached onto the inner surface of the protective wall. The present embodiment is different from the Embodiment 1 only in the shape of the guide. Since the procedure of the RPV replacing work in all the steps is the same as that in Embodiment 1, the explanation of the work of the steps is omitted here.

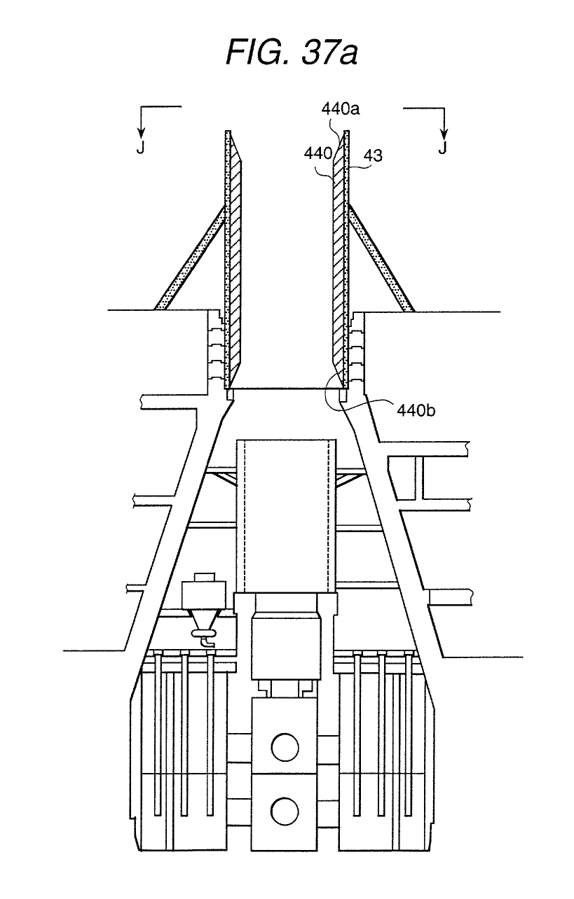

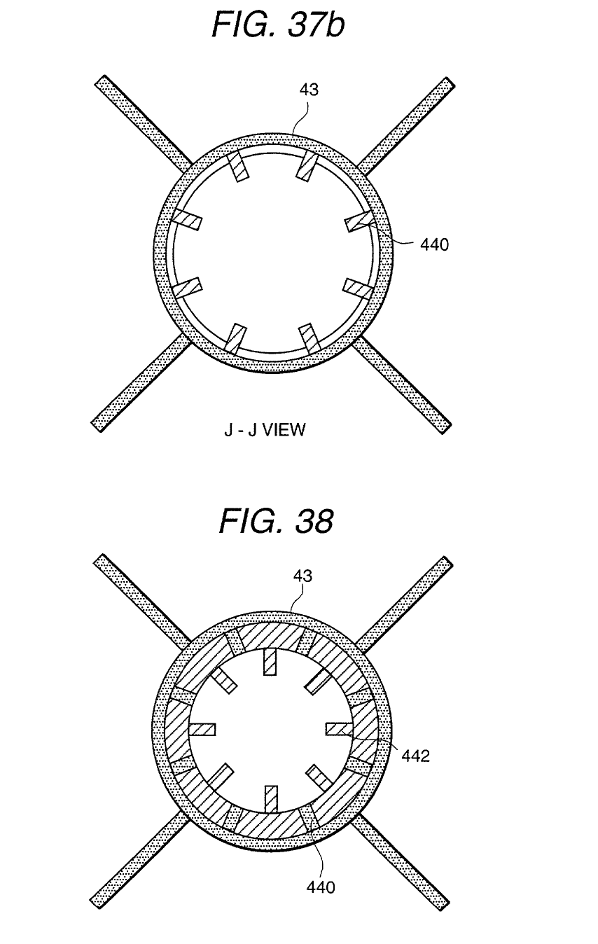

In the present embodiment, the rod-shaped guide 440 attached onto the inner surface of the protective wall 43 is composed of the rod-shaped members each continuing from the upper end to the lower end of the protective wall 43, as shown in FIG. 37a and FIG. 37b. The upper end 440a and the lower end 440b of the rod-shaped guide 440 are tapered in the shape that the thickness of the upper end and the lower end portions of each of the rod-shaped members are thinned toward the upper end and the lower end, respectively, so that the RPV 1 can be smoothly inserted inside the rod-shaped guide 440.

Further, as shown on FIG. 38, an additionally attached guide 442 is attached between the rod-shaped members 440 adjacent to each other in a state of removing the buffer member 43b or in a state of leaving the buffer member 43 attached. By doing so, it is possible to change the position supported by the rod-shaped guide 440 to the position supported by the additionally attached guide 442 depending on the case of carrying out the RPV together with the temporary radiation shield and the case of carrying in the new RPV which is unnecessary to be attached with the temporary radiation shield. Accordingly, the present embodiment can guide an object having a different diameter. FIG. 38 shows the state that the buffer member 43b is removed, and the additionally attached guide 442 is attached.

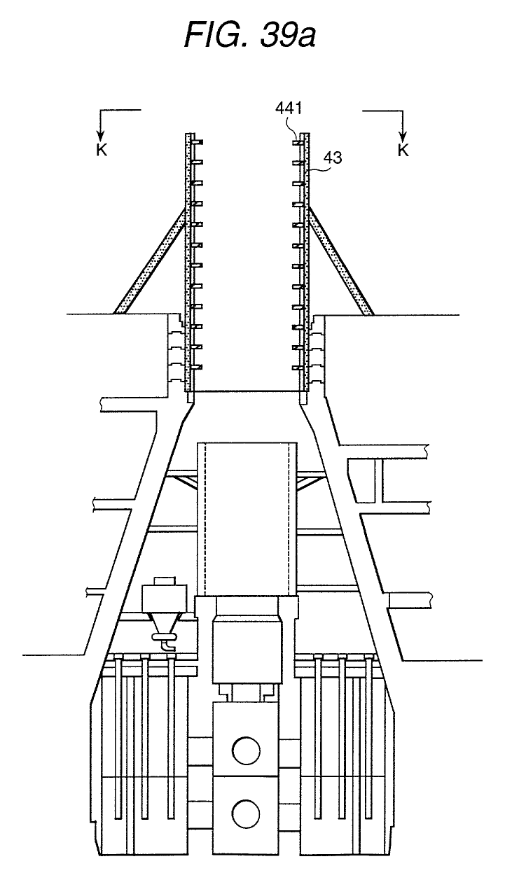

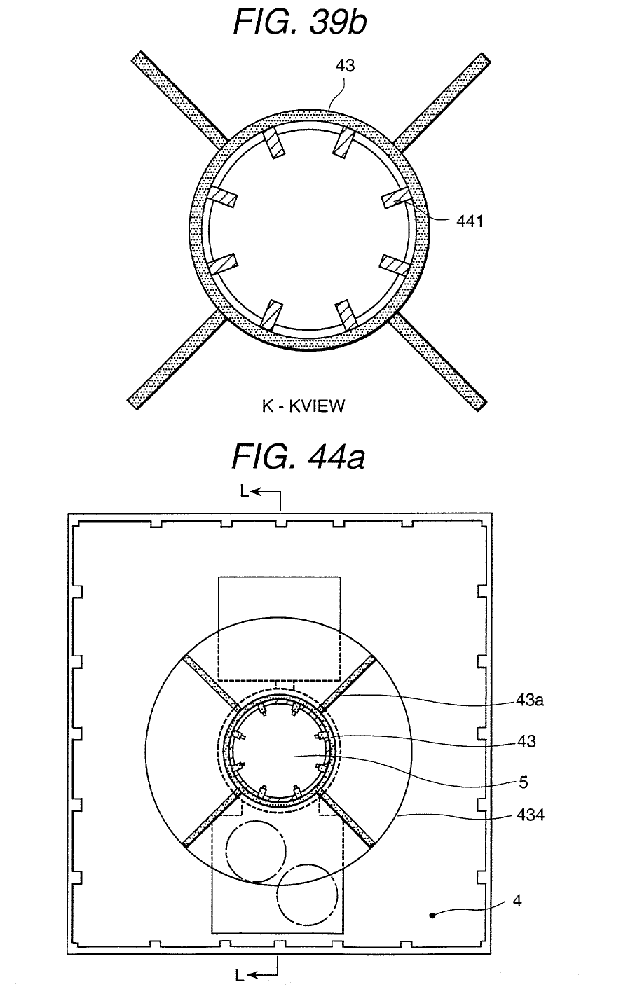

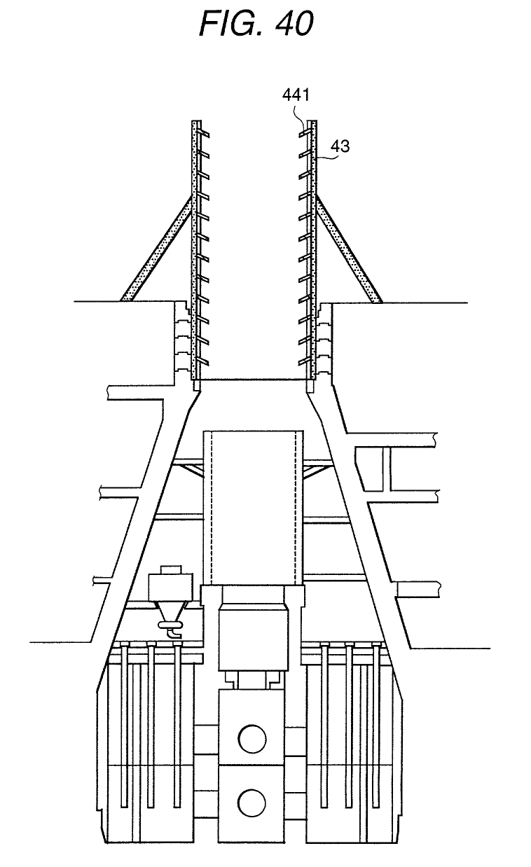

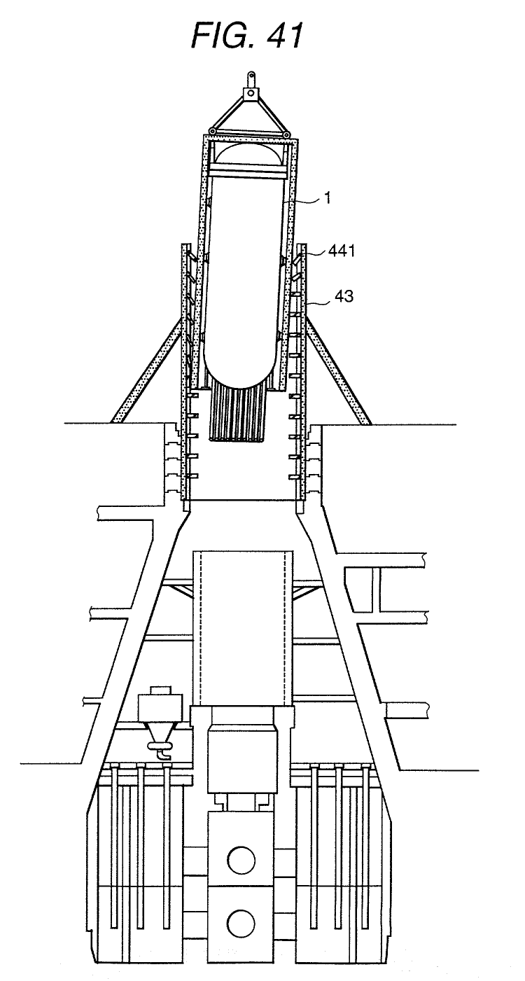

Although in the present embodiment, the guide attached onto the inner surface of the protective wall 43 is the rod-shaped guide 440 composed of the rod-shaped members, plate-shaped decelerating guides 441 may be attached onto the inner surface of the protective wall 43. As shown in FIG. 39a and FIG. 39b, each of the decelerating guides 441 is plate-shaped, and is attached onto the inner surface of the protective wall 43 so that the flat face of the decelerating guide 441 becomes horizontal. Otherwise, as shown in FIG. 40, each of the decelerating guides 441 may be attached onto the protective wall 43 so that the front end of the decelerating guide is tilted downward. The decelerating guides 441 are arranged on the circumference of the inner surface of the protective wall 43 with an equal spacing or an appropriate spacing, and number of lines of the arranged decelerating guides 441 is at least three or more. Further, the decelerating guides 441 are also vertically arranged between the upper end and the lower end of the inner surface of the protective wall 43 with an equal spacing or an appropriate spacing. As shown in FIG. 41, when the RPV 1 accidentally drops down, the dropping speed of the RPV 1 can be decelerated by making the RPV 1 drop while the RPV 1 is fitting against the decelerating guides 441 and breaking the decelerating guides 441.

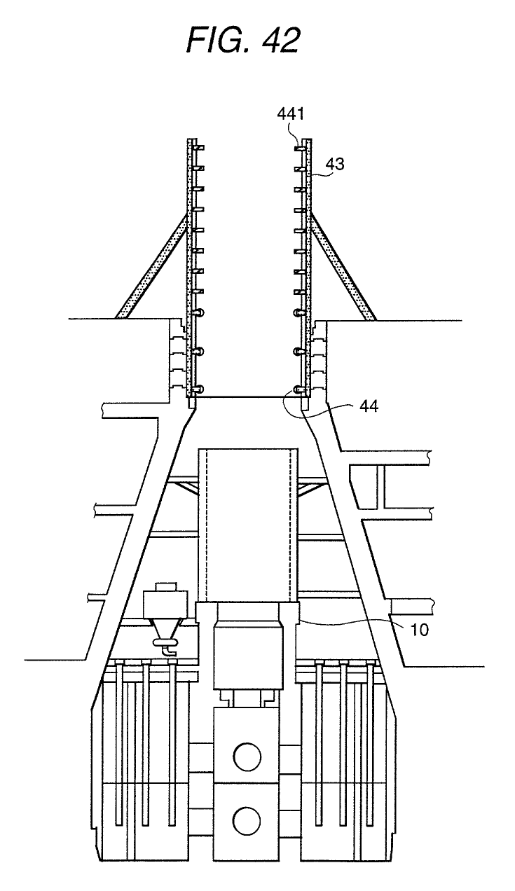

Otherwise, as shown in FIG. 42, it is possible that the decelerating guides 441 are attached onto the upper inner surface of the protective wall 43 and the guides 44 are attached onto the lower inner surface of the protective wall 43. The dropping speed of the RPV 1 can be decelerated by the decelerating guides 441 in the upper side of the protective wall 43, and in the lower side of the protective wall 43, the posture of the dropping RPV 1 can be maintained so that the central axis in the longitudinal direction of the RPV 1 may become nearly vertical to make the RPV 1 drop down onto the top surface of the pedestal 10 through the inside of the protective wall 43. Further, as shown in FIG. 43, the rod-shaped guides 440 may be attached onto the lower inner surface of the protective wall 43 instead of the guides 44.

(Embodiment 10)

As another embodiment in accordance with the present invention, description will be made below on an embodiment in which a protective wall having a supporting plate for load-dispersing the weight of the protective wall over the operating floor. The present embodiment is different from the Embodiment 1 only in the shape of the protective wall 43. Since the procedure of the RPV replacing work in all the steps is the same as that in Embodiment 1, the explanation of the work of the steps is omitted here.

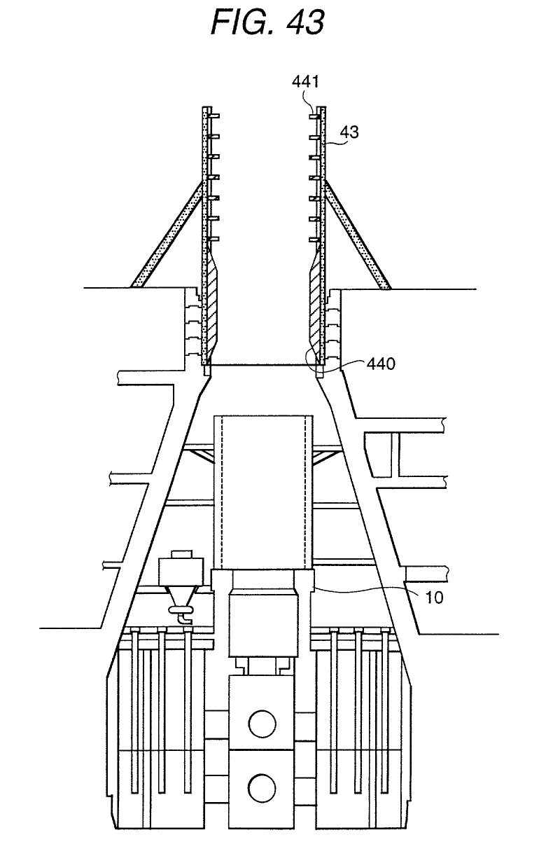

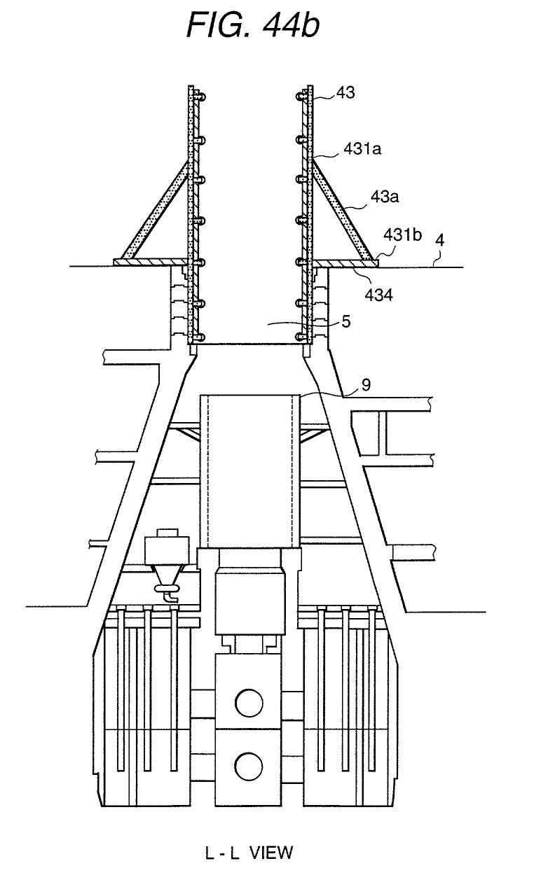

In the present embodiment, as shown in FIG. 44a and FIG. 44b, a plate-shaped supporting plate 434 is joined onto the outer surface of the protective wall 43 or is formed together with the protective wall 43 in a one-piece structure, and the supporting plate 434 is placed on the operating floor 4 in the state that the protective wall 43 is placed inside the reactor well 5, or on the operating floor 4 around the reactor well 5, or on the RSW 9. Although the supporting plate 434 in FIG. 44a is disk-shaped, the shape of the supporting plate 434 may be of a square, or of a polygon, or of an arbitral shape. The upper end 431a of the protective wall supporting member 43a is fixed to an arbitrary position in the height direction of the protective wall 43, and lower end 431b of the supporting member 434 is fixed to an arbitrary position of the supporting plate 434. By doing so, the weight of the protective wall 43 can be load-dispersed not only to the bottom portion of the protective wall 43 but also over the operating floor 4 by the supporting plate 434.

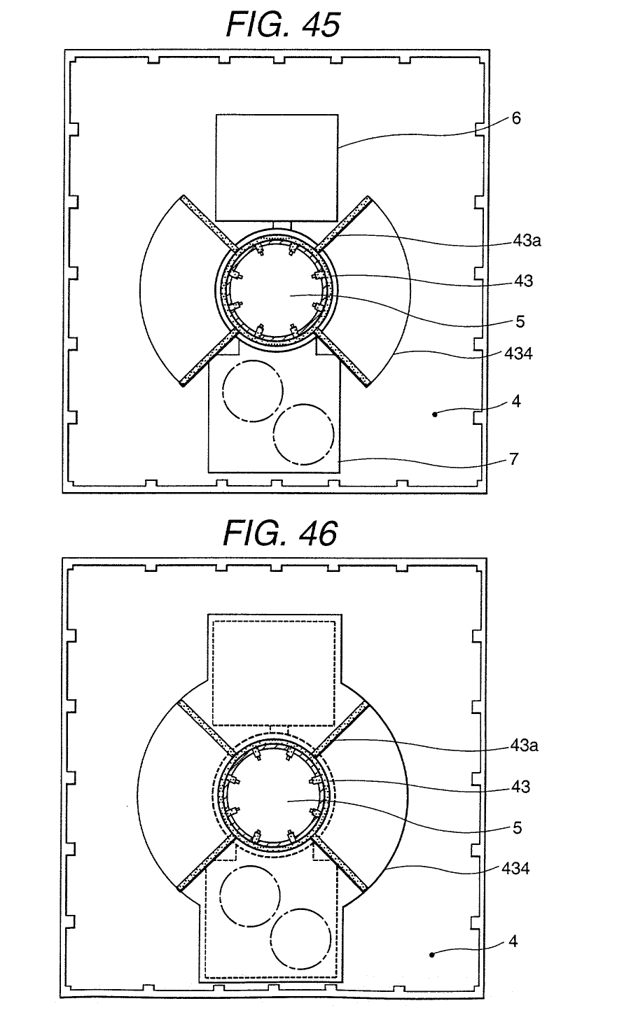

Otherwise, as shown in FIG. 45, the supporting plate 434 may be of a shape which does not cover over the opening portion of the spent fuel pool 6 and the component pool 7. By cutting the portions of the supporting plate 434 covering over the opening portion of the spent fuel pool 6 and the component pool 7 to open the opening portions of the spent fuel pool 6 and the component pool 7, work in the spent fuel pool 6 or in the component pool 7 can be performed even under the state of installing the protective wall 43.

Otherwise, as shown in FIG. 46, the supporting plate 434 may be of a shape which completely covers over the opening portions of the spent fuel pool 6 and the component pool 7. By completely covering over the opening portions of the spent fuel pool 6 and the component pool 7, it is possible to prevent extraneous objects from dropping down to the spent fuel pool 6 and the component pool 7.

According to the present invention, it is possible is to provide a method of handling a structure and an equipment of handling the structure which can make swing of the structure to be transported small when the structure in a reactor building is curried out from the reactor building and/or when the structure is carried into the reactor building from the outside of the reactor building.

What is claimed is:

1. A method of handling a structure, the method comprising the steps of:
setting a beam outside a building inside of which a reactor pressure vessel is installed, said beam passing above said reactor pressure vessel and crossing over said building;
setting a lifting machine having a lifting device for lifting an object to be lifted onto said beam, said lifting machine being moved on said beam;
carrying in a shield for shielding radioactive rays radiated from said reactor pressure vessel into said building through an opening portion provided in a roof of said building;
carrying out said reactor pressure vessel inside said building together with said shield upward through said opening portion using said lifting device;
moving said lifting machine holding said reactor pressure vessel on said beam until a position where said building does not exist below said reactor pressure vessel; and
performing any one of lifting down said reactor pressure vessel using said lifting device to mount said reactor pressure vessel onto a transporting machine and lifting down said reactor pressure vessel into a storage building using said lifting device.

2. A method of handling a structure, the method comprising the steps of:
lifting up a reactor pressure vessel installed inside a building at a position outside said building up to a level above said building using a lifting device of a lifting machine which has the lifting device and moves on a beam, said beam crossing over said building inside of which said reactor pressure vessel is installed;
moving said lifting machine on said beam, and moving said reactor pressure vessel until said reactor pressure vessel is positioned above an opening portion provided in a roof of said building; and
lifting down said reactor pressure vessel to an installation position of said reactor pressure vessel in said building using said lifting device.

3. A method of handling a structure according to any one of claims 1 and 2, wherein said lifting device is a jack type lifting device.

4. A method of handling a structure according to any one of claims 1 to 3, wherein when said lifting machine is moved above said building, said lifting device is moved through an area other than an area just above a fuel storage pool provided inside said building.

5. A method of handling a structure according to any one of claims 1 and 2, wherein said reactor pressure vessel lifted by said lifting device is moved inside a guide device for guiding said reactor pressure vessel, said guide device being arranged inside said building.

6. A method of handling a structure according to claim 5, wherein said guide device is set before vertically moving said reactor pressure vessel inside said building.

7. A method of handling a structure according to claim 6, wherein said guide device is set inside said building at least on any position of an inside of a reactor well, an operating floor around the reactor well and a reactor shield surrounding said reactor pressure vessel.

8. A method of handling a structure according to any one of claims 5 to 7, wherein a buffer member for moderating an impact against a structure moved inside said guide device is arranged inside said guide device.

9. A method of handling a structure according to claim 6, wherein a protective wall is of an expandable telescopic structure.

10. A method of handling a structure according to claim 3, wherein when said beam is set, the method further comprises the steps of:
erecting a column, setting a jack type hoisting device hoisting using said column to said column, and lifting said beam at a level higher than said building using said jack type hoisting device; and
connecting said beam to another column by passing said beam above said building.

11. A method of handling a structure according to claim 10, wherein when said beam is set, a plurality of beams are set by connecting the beams using at least bolts and pads.

12. A method of handling a structure according to claim 3, wherein said jack type lifting machine is set on said beam using said jack type hoisting device.

13. A method of handling a structure according to any one of claim 1 and claim 2, wherein before setting said opening portion, said beam is connected with the roof of said building remaining said building after opening said opening portion.

14. An equipment of handling a structure comprising:
a plurality of columns arranged around a reactor building, said reactor building containing a reactor pressure vessel, and having an opening portion above said reactor pressure vessel;
a beam crossing above said reactor building, both ends of said beam being connected to said columns; and
a lifting machine having a lifting device, said lifting machine being movable on said beam.

15. An equipment of handling a structure according to claim 14, wherein a distance between a lowermost plane of said lifting device and an upper plane of said reactor building is longer than a height of said reactor pressure vessel.

16. An equipment of handling a structure according to any one of claim 14 and claim 15, which comprises a transporting machine movable along said column from the grand level up to at least the height of said reactor building.

17. An equipment of handling a structure according to any one of claim 14 to claim 16, wherein said beam is connected to said building at a position near said opening portion.

18. An equipment of handling a structure according to any one of claim 14 to claim 17, wherein total number of said columns is larger than 6 and smaller than 16.

19. An equipment of handling a structure according to any one of claim 14 to claim 18, wherein said lifting machine comprises a traveling device having a motive power for running on said beam.

20. An equipment of handling a structure according to any one of claim 14 to claim 19, wherein said lifting machine comprises a fixing mechanism for fixing said lifting machine onto said beam.

21. A method of handling a structure according to claim 1, the method further comprising the steps of:
lifting up said reactor pressure vessel together with said shield using said lifting device to the outside above said building; and
then closing a door of said lifting machine for shutting a space through which said reactor pressure vessel has passed, said door of said lifting machine existing between said reactor pressure vessel and said building in a vertical direction.

22. A method of handling a structure according to claim 2, the method further comprising the steps of:
lifting up said reactor pressure vessel using said lifting device up to a level where a lowermost portion of said reactor pressure vessel becomes higher than the roof of said the outside above said building;
then closing a door of said lifting machine for shutting at least a part of a portion of projecting said reactor pressure vessel in a vertical downward direction, said door of said lifting machine being arranged in said lifting machine in a level higher than the, roof of said building in the vertical direction and in a level lower than the lowermost position of said reactor pressure vessel;
moving said lifting machine until a new reactor pressure vessel comes to above said opening portion, and opening said door of said lifting machine; and
setting said new reactor pressure vessel to the position where said reactor pressure vessel has been installed.

23. An equipment of handling a structure according to any one of claims 14 to 20, which comprises a storage building for said reactor pressure vessel in a position under one beam among said beams, said lifting machine being moved on said one beam, said position being positioned under said beam within a moving range of said lifting machine.

24. A method of handling a structure, the method comprising the steps of:
setting a beam outside a building inside of which a reactor pressure vessel is installed, said beam passing above said reactor pressure vessel and crossing over said building;
setting a lifting machine having a lifting device for lifting said reactor pressure vessel onto said beam, said lifting machine being moved on said beam;
carrying in a shield for shielding radioactive rays radiated from said reactor pressure vessel into said building through an opening portion provided in a roof of said building;
carrying out said reactor pressure vessel together with said shield upward from said building using said lifting device;
moving said lifting machine on said beam until a position where said building does not exist below said reactor pressure vessel;
then lowering said lifting machine hanging said reactor pressure vessel down to the ground using a jack type hoisting device arranged adjacent to said building;
moving said lifting device on a transporting rail installed in the ground until a bottom portion of said reactor pressure vessel comes to a storage building for said reactor pressure vessel; and
lifting down said reactor pressure vessel into said storage building using said lifting device provided in said lifting machine.

25. A method of handling a structure according to any one of claim 1, claim 2 and claim 24, wherein said reactor pressure vessel is a reactor pressure vessel for a nuclear power plant.

26. A method of handling a structure according to any one of claim 1 and claim 24, wherein when the step of setting said beam outside said building so as to pass above said reactor pressure vessel and to cross over said building is let be a first process; and the step of setting said lifting machine having said lifting device on said lifting machine and moving on said beam be a second process; and the step of carrying in said shield into said building through the opening portion provided in the roof of said building be a third process,
said first process and said second process are performed during operating the reactor before starting a first scheduled inspection period for performing said third process or during a second scheduled inspection period performed before performing said first scheduled inspection period.

27. A method of handling a structure according to any one of claim 1 to claim 3 and claim 24, wherein when said reactor pressure vessel is carried out from said building, said lifting machine is moved above said building in a direction departing from a fuel storage pool.

28. A method of handling a structure according to any one of claim 3, claim 10 to claim 12 and claim 24, wherein said jack type hoisting device is arranged in the side of a wall provided a large article carrying-in port outside said reactor building.
